(19) United States
(12) Patent Application Publication
(10) Pub. No.: US 2026/0050882 A1
(43) Pub. Date: Feb. 19, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Shinichiro HAMADA, Osaka (JP)

(21) Appl. No.: 19/369,883

(22) Filed: Oct. 27, 2025

Related U.S. Application Data
(63) Continuation of application No. PCT/JP2024/013106, filed on Mar. 29, 2024.

(30) Foreign Application Priority Data
Apr. 28, 2023 (JP) 2023-074654

(51) Int. Cl. G06Q 10/083

(52) U.S. Cl. CPC G06Q 10/0843

(57) ABSTRACT

An information processing method includes acquiring a transportation request for each of one or more transportation objects, the transportation request including a starting point, an ending point, and a first arrival date/time that indicates a date and time at which each of the one or more transportation objects arrives at the starting point, creating a transportation plan on the basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and outputting the transportation plan.

### FIELD OF INVENTION

The present disclosure relates to a technique of creating a transportation plan for transporting one or more transportation objects by one or more vehicles.

### BACKGROUND ART

Conventionally, demand-responsive transport by a bus (demand bus) is known. In the demand bus, like a taxi, an operation route is determined from a transportation request of a customer. A demand bus service and a physical distribution service for delivering packages have similar business structures. In the demand bus service and the physical distribution service, a transportation object group to which a starting point and an ending point are given is transported by using a predetermined number of vehicles under a condition that a transportation object is allowed to board together. However, a transportation object of the physical distribution service is a package, and a transportation object of the demand bus service is a traveler. Conventionally, a technique of automatically creating a transportation plan for efficiently performing transportation operations of the demand bus service and the physical distribution service by a computer has been studied.

For example, Non-Patent Literature 1 discloses that a dial-a-ride problem method (DARP method), which is a representative method assuming application to traveler transportation such as on-demand bus service, and a pickup-and-delivery problem method (PDP method), which is a representative method assuming application to the physical distribution service, solve the same problem except for some detailed settings.

Both the DARP method and the PDP method are defined for the purpose of minimizing a total edge cost included in the transportation plan of each vehicle. An edge corresponds to a route between visiting spots, such as a bus stop or a delivery destination, and the edge cost corresponds to a time or a distance of the route. That is, both the DARP method and the PDP method aim to minimize a sum of an operation time or a moving distance of the vehicle (optimization index). According to a transportation plan evaluation focusing on the vehicle, it is possible to shorten an operating time required for responding to a given transportation request, to perform a large amount of transportation within a predetermined time, and to make the vehicle available early to respond to a future transportation request.

On the other hand, in the demand bus service and the physical distribution service, there is also a need to minimize a total time during which the transportation object is loaded on the vehicle (transportation time). For example, in the demand bus service, the transportation plan is created such that a boarding time of each traveler is shortened. According to a transportation plan evaluation focusing on the transportation object, the boarding time is shortened, and thus free time of a passenger is increased. Thus, the passenger can allocate the time to other things to do, such as shopping. The boarding time, which restricts behavior, is not comfortable. Therefore, shortening the boarding time can reduce a mental burden on the passenger.

Conventionally, multi-depot delivery is known in which a product may be delivered from any of a plurality of warehouses. By delivering a product from a warehouse close to the delivery destination, a period from loading to unloading of the product is reduced. In the multi-depot delivery, since the timing of loading the product can be delayed, a degree of freedom in product preparation such as production planning increases. Accordingly, the production efficiency can be enhanced. In the case of delivering a perishable product such as milk or fresh food, the product can be delivered to the delivery destination while kept highly fresh if delivered from a warehouse close to the delivery destination.

For example, in Patent Literature 1, a vehicle operation schedule including a route that minimizes the boarding time of all passengers and an estimated node arrival time is created.

However, in the conventional technique described above, a holding time from the arrival of the transportation object at the starting point to the arrival of the vehicle at the starting point is not considered, and further improvement is required.
Patent Literature 1: JP 2004-280734 A
Non-Patent Literature 1: Renan Artur Lopes Eccel, Rodrigo Castelan Carlson, “Analysis of pick-up and delivery and dial-a-ride problems dynamization methods and benchmark instances”, TRANSPORTES 28 (4), November 2020, p. 103-116

### SUMMARY OF THE INVENTION

The present disclosure has been made to solve the above problem, and an object of the present disclosure is to provide a technique capable of shortening a holding time from arrival of a transportation object at a starting point to arrival of a vehicle at the starting point.

An information processing method of the present disclosure is an information processing method in a computer, the method including acquiring a transportation request for each of one or more transportation objects, the transportation request including a starting point for starting transportation, an ending point for ending transportation, and a first arrival date/time that indicates a date and time at which each of the one or more transportation objects arrives at the starting point, creating a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and outputting the transportation plan created.

The present disclosure can shorten the holding time from the arrival of the transportation object at the starting point to the arrival of the vehicle at the starting point.

### BRIEF DESCRIPTION OF THE DRAWINGS

FIG. 1 is a diagram illustrating an example of a transportation plan in a demand bus service.

FIG. 2 is a diagram illustrating an example of a transportation plan in multi-depot delivery.

FIG. 3 is a diagram illustrating an overall configuration of a vehicle dispatch management system in a first embodiment of the present disclosure.

FIG. 4 is a diagram illustrating an example of vehicle definition data in the first embodiment.

FIG. 5 is a diagram illustrating an example of transportation object definition data in the first embodiment.

FIG. 6 is a diagram illustrating an example of spot timetable data in the first embodiment.

FIG. 7 is a diagram illustrating an example of inter-spot distance table data in the first embodiment.

FIG. 8 is a diagram illustrating an example of a transportation plan in the first embodiment.

FIG. 9 is a first flowchart for describing an operation of a transportation plan creator of the transportation plan creation server in the first embodiment of the present disclosure.

FIG. 10 is a second flowchart for describing the operation of the transportation plan creator of the transportation plan creation server in the first embodiment of the present disclosure.

FIG. 11 is a third flowchart for describing the operation of the transportation plan creator of the transportation plan creation server in the first embodiment of the present disclosure.

FIG. 12 is a fourth flowchart for describing the operation of the transportation plan creator of the transportation plan creation server in the first embodiment of the present disclosure.

FIG. 13 is a schematic diagram for describing processing of creating an initial solution of a transportation plan by an initial solution creator in the first embodiment.

FIG. 14 is a schematic diagram for describing processing of creating a hypothesis solution of a transportation plan by an improved solution creator in the first embodiment.

FIG. 15 is a flowchart for describing solution evaluation processing of the transportation plan creation server in the first embodiment.

FIG. 16 is a diagram illustrating an overall configuration of a vehicle dispatch management system in a second embodiment of the present disclosure.

FIG. 17 is a diagram illustrating an example of coefficient setting data in the second embodiment.

FIG. 18 is a flowchart for describing an operation of an operation management server in the second embodiment of the present disclosure.

FIG. 19 is a diagram illustrating an overall configuration of a vehicle dispatch management system in a third embodiment of the present disclosure.

FIG. 20 is a diagram illustrating an example of coefficient setting data in the third embodiment.

FIG. 21 is a diagram illustrating an example of transportation object definition data in the third embodiment.

FIG. 22 is a flowchart for describing an operation of an operation management server in the third embodiment of the present disclosure.

FIG. 23 is a diagram illustrating an overall configuration of a vehicle dispatch management system in a fourth embodiment of the present disclosure.

FIG. 24 is a diagram illustrating an example of coefficient setting data in the fourth embodiment.

FIG. 25 is a diagram illustrating an example of transportation object definition data in the fourth embodiment.

FIG. 26 is a flowchart for describing an operation of an operation management server in the fourth embodiment of the present disclosure.

### DETAILED DESCRIPTION

### (Knowledge Underlying Present Disclosure)

Depending on the situation, different determination results may be obtained between the transportation plan evaluation focusing on the vehicle and the transportation plan evaluation focusing on the transportation object.

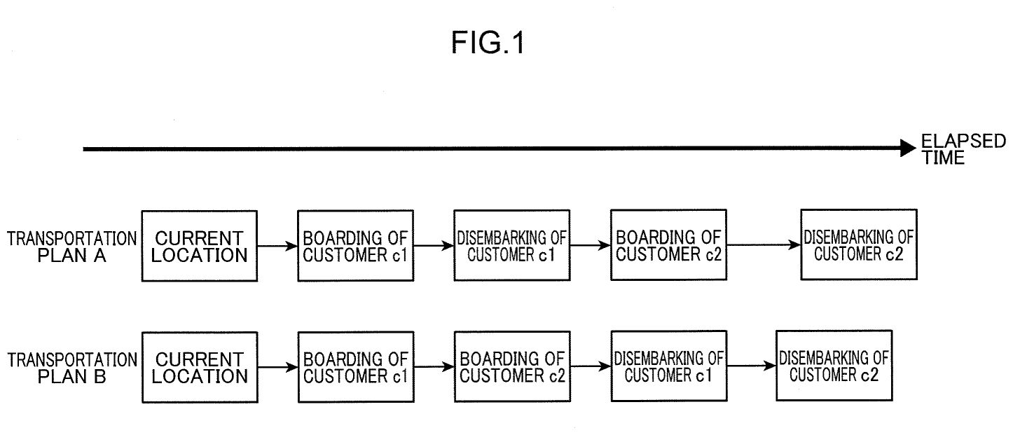

FIG. 1 is a diagram illustrating an example of a transportation plan in a demand bus service. The horizontal axis in FIG. 1 represents elapsed time.

A transportation plan A and a transportation plan B illustrated in FIG. 1 indicate jobs for transporting a customer c1 and a customer c2, and a boarding action and a disembark action of the customer c1 and the customer c2 are arranged in time series.

In the transportation plan A, the vehicle that has departed from a current location first boards the customer c1, then disembarks the customer c1, then boards the customer c2, and finally disembarks the customer c2. On the other hand, in the transportation plan B, the vehicle that has departed from the current location first boards the customer c1, then boards the customer c2, then disembarks the customer c1, and finally disembarks the customer c2.

An operation time from the departure from the current location of the transportation plan B to the final disembarking of the customer c2 is shorter than the operation time from the departure from the current location of the transportation plan A to the final disembarking of the customer c2. On the other hand, a transportation time from the boarding to the disembarking of the customer c1 of the transportation plan A is shorter than a transportation time from the boarding to the disembarking of the customer c1 of the transportation plan B, and a transportation time from the boarding to the disembarking of the customer c2 of the transportation plan A is shorter than a transportation time from the boarding to the disembarking of the customer c2 of the transportation plan B.

In the transportation plan evaluation focusing on the vehicle, since the operation time of the vehicle of the transportation plan B is shorter than the operation time of the vehicle of the transportation plan A, it is determined that the transportation plan B is more preferable than the transportation plan A. However, in the transportation plan evaluation focusing on the transportation object, since the transportation time in which the customer c1 and the customer c2 of the transportation plan A are on board is shorter than the transportation time in which the customer c1 and the customer c2 of the transportation plan B are on board, it is determined that the transportation plan A is more preferable than the transportation plan B. Although the transportation of the customers is described in FIG. 1, a similar result can be obtained for transportation of packages.

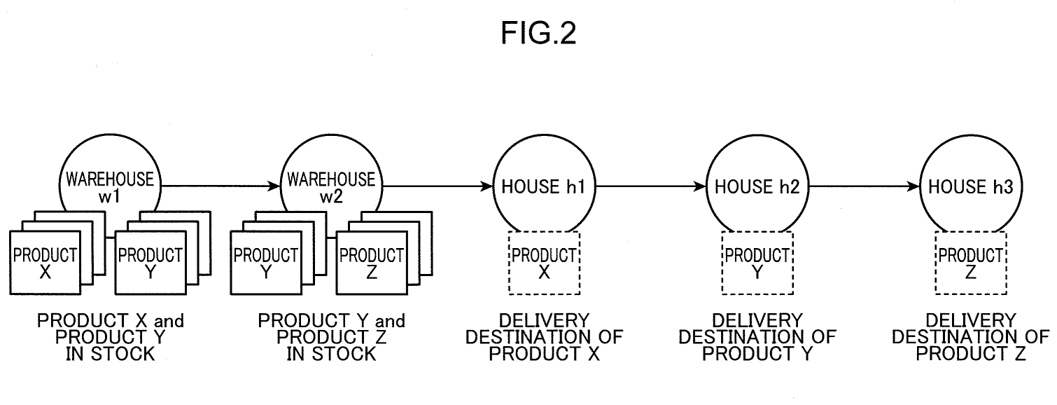

FIG. 2 is a diagram illustrating an example of a transportation plan in multi-depot delivery.

In FIG. 2, a house h1 is the delivery destination of a product X, a house h2 is the delivery destination of a product Y, and a house h3 is the delivery destination of a product Z. The product X and the product Y are stored in a warehouse w1, and the product Y and the product Z are stored in a warehouse w2. The warehouse w1, the warehouse w2, the house h1, the house h2, and the house h3 are linearly arranged in a geographical relationship. In the transportation plan illustrated in FIG. 2, the vehicle visits the warehouse w1, the warehouse w2, the house h1, the house h2, and the house h3 in that order, but it is possible to select from which warehouse the product Y is picked up.

In the transportation plan evaluation focusing on the vehicle, since the operation time of the vehicle does not change regardless of which warehouse the product Y is picked up from, the evaluation results are the same. On the other hand, in the transportation plan evaluation focusing on the transportation object, since the warehouse w2 is closer to the delivery destination of the product Y than the warehouse w1, it is determined that the transportation plan for picking up the product Y from the warehouse w2 is more preferable than the transportation plan for picking up the product Y from the warehouse w1.

In the case of traveler transportation such as demand bus, a traveler needs to stand by at a bus stop from a time when the traveler arrives at the bus stop to a time when the bus arrives at the bus stop. Reduction of a standby time of travelers is also one point to be considered in the creation of a transportation plan, but is not considered in the creation of a conventional transportation plan.

In the case of package transportation of a physical distribution service, a package is stored in a warehouse until the package is carried out after being carried into the warehouse. The package may deteriorate while being stored in the warehouse. Increasing a rotation rate of the warehouse leads to improvement of efficiency of an entire supply chain. Therefore, reduction of a storage period of packages in the warehouse is also one point to be considered in the creation of a transportation plan, but is not considered in the creation of a conventional transportation plan.

In order to solve the above problem, the following technique is disclosed.

(1) An information processing method according to an aspect of the present disclosure is an information processing method in a computer, the method including acquiring a transportation request for each of one or more transportation objects, the transportation request including a starting point for starting transportation, an ending point for ending transportation, and a first arrival date/time that indicates a date and time at which each of the one or more transportation objects arrives at the starting point, creating a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and outputting the transportation plan created.

In this configuration, the transportation plan for transporting one or more transportation objects is created on the basis of the sum of the one or more holding costs that correspond to the difference between the first arrival date/time indicating the date and time at which each of the one or more transportation objects arrives at the starting point and the second arrival date/time indicating the date and time at which one or more vehicles arrive at the starting point of each of the one or more transportation objects and the one or more transportation costs required for transporting each of the one or more transportation objects from the starting point to the ending point.

Therefore, since the transportation plan is created in consideration of not only the transportation cost required for transporting the transportation object from the starting point to the ending point but also the holding cost from the arrival of the transportation object at the starting point to the arrival of the vehicle at the starting point, the holding time from the arrival of the transportation object at the starting point to the arrival of the vehicle at the starting point can be shortened.

(2) In the information processing method according to (1), in the creating of the transportation plan, the transportation plan that defines the one or more transportation objects to be transported by each of the one or more vehicles may be created to minimize a sum of the one or more holding costs and the one or more transportation costs.

This configuration can shorten the holding time from the arrival of the transportation object at the starting point to the arrival of the vehicle at the starting point together with the transportation cost required for transporting the transportation object from the starting point to the ending point.

(3) In the information processing method according to (1) or (2), in the creating of the transportation plan, the transportation plan may be created by arranging, for each of the one or more vehicles, the starting point and the ending point for the one or more transportation objects to be transported by each of the one or more vehicles in time series.

This configuration can create the transportation plan in which the starting point and the ending point of one or more transportation objects to be transported by one or more vehicles are arranged in time series for each of the one or more vehicles.

(4) In the information processing method according to any one of (1) to (3), in the creating of the transportation plan, the transportation plan may be created on a basis of a sum of one or more operation costs required for moving from a first departure point to the ending point at a last end of the vehicle, the one or more holding costs, and the one or more transportation costs for each of the one or more vehicles included in the transportation plan.

This configuration creates the transportation plan on the basis of the sum of one or more operation costs required for moving from the first departure point to the ending point at the last end of the vehicle, one or more holding costs, and one or more transportation costs for each of one or more vehicles included in the transportation plan.

Therefore, the transportation plan can be optimized in consideration of the operation cost of the vehicle, the holding cost of the transportation object, and the transportation cost of the transportation object.

(5) In the information processing method according to any one of (1) to (4), in the creating of the transportation plan, when there is a plurality of starting point candidates for one transportation object among the one or more transportation objects, the starting point candidate having the sum that is smallest among the plurality of starting point candidates may be used as the starting point of the one transportation object.

In this configuration, since the starting point candidate having the smallest sum of the holding time and the transportation cost is selected as the starting point of the transportation object from among the plurality of starting point candidates, it is possible to increase the number of options of a transportation route when the transportation plan is created, and it is possible to create a more optimal transportation plan.

(6) In the information processing method according to any one of (1) to (5), the one or more transportation objects may include one or more packages, the starting point may include a location of a warehouse that stores the package, and in the creating of the transportation plan, the transportation plan may be created so that one of the holding cost or the transportation cost is smaller than another one of the holding cost or the transportation cost on a basis of an average space occupancy rate obtained by dividing a sum of current storage volumes of one or more warehouses that store the one or more packages by a sum of maximum storage volumes of the one or more warehouses.

This configuration can create the transportation plan so as not to exceed a storage upper limit of the entire one or more warehouses.

(7) In the information processing method according to (6), in the creating of the transportation plan, the transportation plan may be created so that the holding cost is smaller than the transportation cost when the average space occupancy rate is equal to or more than a first threshold, and the transportation plan may be created so that the transportation cost is smaller than the holding cost when the average space occupancy rate is less than a second threshold.

In this configuration, when the average space occupancy rate of one or more warehouses is high, the transportation plan is created so that the holding cost is smaller than the transportation cost. Therefore, by shortening the holding time, the average space occupancy rate of one or more warehouses can be reduced, and it is possible to prevent a package from being carried in exceeding the storage upper limit of the entire one or more warehouses.

(8) In the information processing method according to any one of (1) to (5), the one or more transportation objects may include one or more travelers, and in the creating of the transportation plan, the transportation plan may be created so that one of the holding cost or the transportation cost is smaller than another one of the holding cost or the transportation cost on a basis of a number of the one or more travelers included in the transportation request.

This configuration can create the transportation plan so that the starting point is not congested for a plurality of travelers.

(9) In the information processing method according to (8), in the creating of the transportation plan, the transportation plan may be created so that the holding cost is smaller than the transportation cost when the number of the one or more travelers is equal to or more than a first threshold, and the transportation plan may be created so that the transportation cost is smaller than the holding cost when the number of the one or more travelers is less than a second threshold.

In this configuration, when the starting point is congested for a plurality of travelers, the transportation plan is created so that the holding cost is smaller than the transportation cost. Therefore, by shortening the holding time, the number of travelers standing by at the starting point can be reduced, and the starting point can be prevented from being congested.

(10) In the information processing method according to any one of (1) to (5), the one or more transportation objects may include one or more packages, and in the creating of the transportation plan, the transportation plan may be created so that one of the holding cost or the transportation cost is smaller than another one of the holding cost or the transportation cost on a basis of an average grace period obtained by dividing a sum of one or more grace periods from the first arrival date/time of each of the one or more packages to an expiration date of each of the one or more packages by a number of the one or more packages.

This configuration can create the transportation plan created so that the package reaches the ending point by the expiration date.

(11) In the information processing method according to (10), in the creating of the transportation plan, the transportation plan may be created so that the holding cost is smaller than the transportation cost when the average grace period is less than a first threshold, and the transportation plan may be created so that the transportation cost is smaller than the holding cost when the average grace period is equal to or more than a second threshold.

In this configuration, when the average grace period from the first arrival date/time of one or more packages to the expiration date is short, the transportation plan is created so that the holding cost is smaller than the transportation cost. Therefore, by shortening the holding time, the period during which the package is stored in the warehouse that is the starting point can be shortened, and the package can be reliably delivered by the expiration date.

The present disclosure can be implemented not only as an information processing method for executing the characteristic processing as described above, but also as an information processing device or the like having a characteristic configuration corresponding to characteristic processing executed by the information processing method. The present disclosure can also be implemented as a computer program that causes a computer to execute characteristic processing included in the information processing method described above. Therefore, an effect similar to the effect in the above information processing method can also be achieved by another aspect described below.

(12) An information processing device according to another aspect of the present disclosure includes an acquisition part that acquires a transportation request for each of one or more transportation objects, the transportation request including a starting point for starting transportation, an ending point for ending transportation, and a first arrival date/time that indicates a date and time at which each of the one or more transportation objects arrives at the starting point, a creator that creates a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and an output part that outputs the transportation plan created.

(13) An information processing program according to another aspect of the present disclosure causes a computer to function to acquire a transportation request for each of one or more transportation objects, the transportation request including a starting point for starting transportation, an ending point for ending transportation, and a first arrival date/time that indicates a date and time at which each of the one or more transportation objects arrives at the starting point, create a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and output the transportation plan created.

(14) A non-transitory computer-readable recording medium according to another aspect of the present disclosure records an information processing program, the information processing program causing a computer to function to acquire a transportation request for each of one or more transportation objects, the transportation request including a starting point for starting transportation, an ending point for ending transportation, and a first arrival date/time that indicates a date and time at which each of the one or more transportation objects arrives at the starting point, create a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point, and output the transportation plan created.

Hereinafter, embodiments of the present disclosure will be described with reference to the accompanying drawings. Each of embodiments described below illustrates a specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, respective contents can be combined.

### First Embodiment

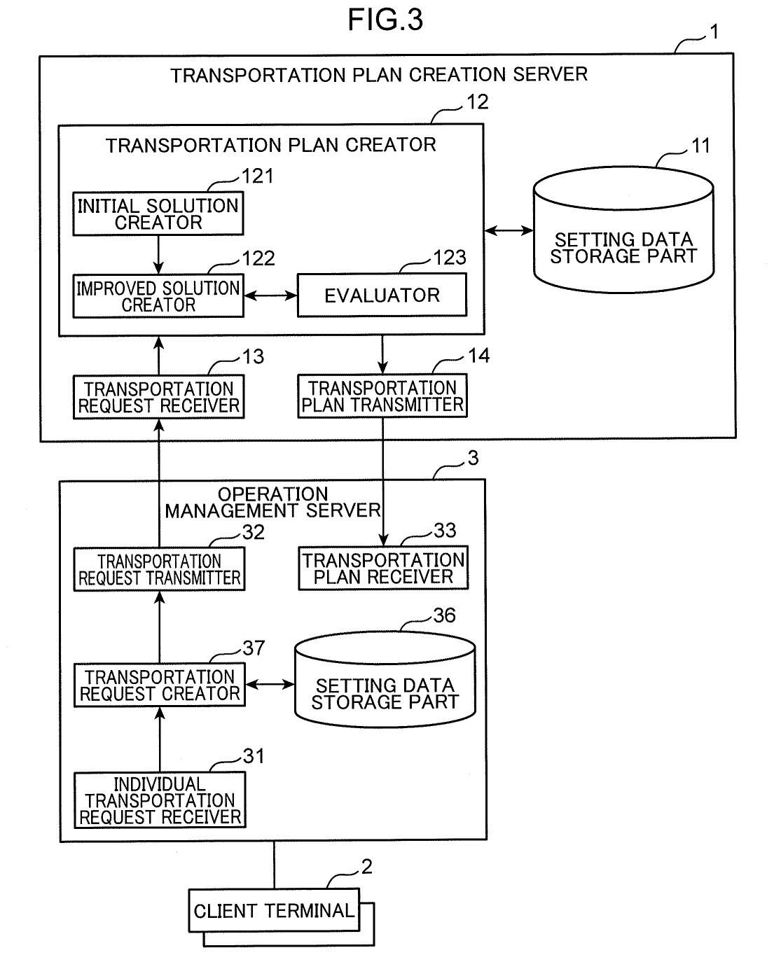

FIG. 3 is a diagram illustrating an overall configuration of a vehicle dispatch management system in a first embodiment of the present disclosure.

The vehicle dispatch management system illustrated in FIG. 3 includes a transportation plan creation server 1, a plurality of client terminals 2, and an operation management server 3.

The client terminal 2 is a smartphone, a tablet computer, or a personal computer, for example, and is carried by a client who requests transportation of a transportation object by a vehicle. The transportation object is a traveler or a package. The vehicle is, for example, a bus that transports a plurality of travelers or a truck that transports a plurality of packages. The client is the traveler himself or a delivery company of the package. The client terminal 2 receives inputs of a transportation object amount, a starting point at which transportation of the transportation object is started, an ending point at which the transportation of the transportation object is ended, and a check-in date/time (first arrival date/time) indicating a date and time at which the transportation object arrives at the starting point by the client. The client terminal 2 transmits individual transportation request data including a transportation object ID, the transportation object amount, the starting point, the ending point, and the check-in date/time to the operation management server 3. The basic configuration of each of the plurality of client terminals 2 is the same.

The transportation object ID is identification information for identifying the transportation object. When the transportation object is a traveler, the transportation object ID is stored in advance in a memory of the client terminal 2. When the transportation object is a package, the transportation object ID is input by the client. When the transportation object is a traveler, the transportation object amount represents the number of travelers. When the transportation object is a package, the transportation object amount represents a weight or a volume of the package. When the transportation object is a traveler, the starting point represents a bus stop where the traveler boards, and the ending point represents a bus stop where the traveler disembarks. When the transportation object is a package, the starting point represents a location of a warehouse for loading the package, and the ending point represents a delivery destination for delivering the package.

In the first embodiment, an operation route and a stop place (bus stop, a location of a warehouse, or a delivery destination) of the vehicle are determined in advance. The traveler or the delivery company selects the starting point and the ending point from a plurality of stop places set in advance on the operation route. The traveler or the delivery company inputs a date and time when the traveler or the package arrives at the starting point as the check-in date/time.

In the first embodiment, the starting point and the ending point of the transportation object are predetermined stop places (bus stops). However, the present disclosure is not limited to the places, and the starting point and the ending point may be arbitrary places specified by the traveler or the delivery company. In this case, the traveler or the delivery company may input the starting point and the ending point on a map displayed on the client terminal 2, or may input an address, a facility name, or the like as the starting point and the ending point to the client terminal 2.

The operation management server 3 is a server operated by an operating company of one or more vehicles, and manages the operation of the one or more vehicles. The operation management server 3 includes an individual transportation request receiver 31, a transportation request transmitter 32, a transportation plan receiver 33, a setting data storage part 36, and a transportation request creator 37. The operation management server 3 is communicably connected to the plurality of client terminals 2 via a network. The network is the Internet, for example.

The individual transportation request receiver 31, the transportation request transmitter 32, and the transportation plan receiver 33 are implemented by a communication module.

The individual transportation request receiver 31 receives the individual transportation request data transmitted by each of the plurality of client terminals 2. The individual transportation request receiver 31 stores the received individual transportation request data in a memory (not illustrated).

The setting data storage part 36 stores in advance vehicle definition data in which one or more vehicle IDs for identifying one or more vehicles, a loading amount upper limit of each vehicle, and a standby base of each vehicle are associated with each other.

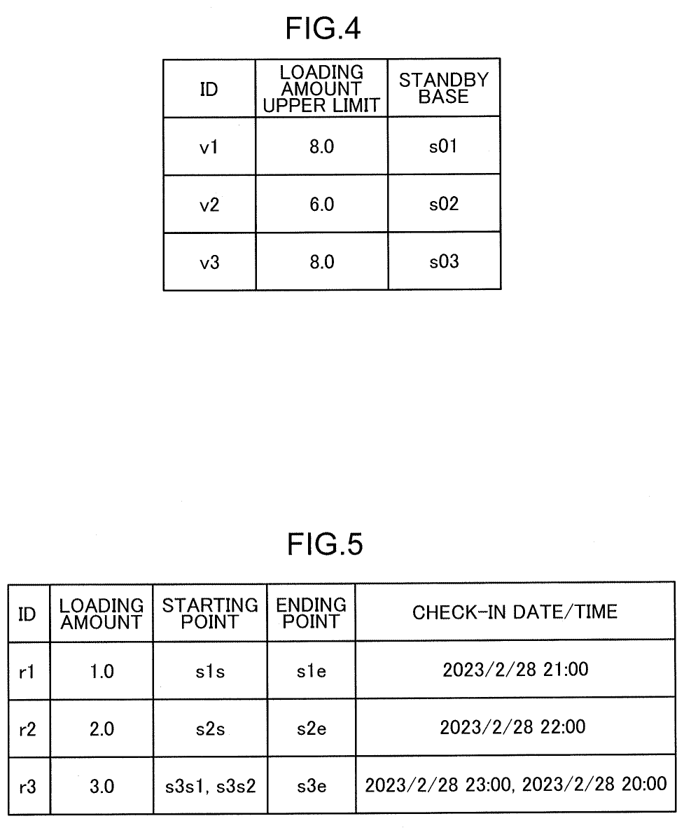

FIG. 4 is a diagram illustrating an example of vehicle definition data in the first embodiment.

The vehicle definition data is data indicating one or more vehicle IDs for identifying one or more vehicles, a loading amount upper limit of each vehicle, and a standby base of each vehicle. As illustrated in FIG. 4, in the first embodiment, the vehicle definition data includes three vehicle IDs of a first vehicle v1, a second vehicle v2, and a third vehicle v3.

When the transportation object is a traveler, the loading amount upper limit represents a capacity of the vehicle, and when the transportation object is a package, the loading amount upper limit represents a maximum weight or a maximum volume of the package that can be loaded on the vehicle. The loading amount upper limit illustrated in FIG. 4 represents the maximum weight of the package that can be loaded on the vehicle, and represents that the loading amount upper limit of the first vehicle v1 is 8.0 kg, the loading amount upper limit of the second vehicle v2 is 6.0 kg, and the loading amount upper limit of the third vehicle v3 is 8.0 kg. The standby base represents a place where each vehicle is on standby. Each vehicle first departs from the standby base and moves toward the starting point and the ending point of each transportation object. The first vehicle v1, the second vehicle v2, and the third vehicle v3 are associated with a first standby base s01, a second standby base s02, and a third standby base s03. The first standby base s01, the second standby base s02, and the third standby base s03 may be the same place or different places.

The transportation request creator 37 acquires the vehicle definition data from the setting data storage part 36. On the basis of one or more pieces of individual transportation request data received by the individual transportation request receiver 31, the transportation request creator 37 creates transportation object definition data in which a transportation object ID for identifying each of one or more transportation objects, a loading amount of each of the one or more transportation objects, a starting point for starting transportation of each of the one or more transportation objects, an ending point for ending transportation of each of the one or more transportation objects, and a check-in date/time (first arrival date/time) indicating a date and time at which each of the one or more transportation objects arrives at the starting point are associated. The transportation request creator 37 creates the transportation object definition data in which the one or more pieces of the individual transportation request data received by the individual transportation request receiver 31 are integrated. The transportation request creator 37 creates transportation request data including the vehicle definition data and the transportation object definition data.

FIG. 5 is a diagram illustrating an example of the transportation object definition data in the first embodiment.

The transportation object definition data is data indicating the transportation object ID for identifying each of one or more transportation objects, the loading amount of each of the one or more transportation objects, the starting point for starting transportation of each of the one or more transportation objects, the ending point for ending transportation of each of the one or more transportation objects, and the check-in date/time (first arrival date/time) indicating a date and time at which each of the one or more transportation objects arrives at the starting point. As illustrated in FIG. 5, in the first embodiment, the transportation object definition data includes three transportation object IDs of a first transportation object r1, a second transportation object r2, and a third transportation object r3.

When the transportation object is a traveler, the loading amount represents the number of travelers on the vehicle, and when the transportation object is a package, the loading amount represents a weight or a volume of the package to be loaded on the vehicle. When the transportation object is a traveler, the starting point represents a bus stop where the traveler boards the vehicle, and when the transportation object is a package, the starting point represents a warehouse where the package is loaded on the vehicle. When the transportation object is a traveler, the ending point represents a bus stop where the traveler disembarks the vehicle, and when the transportation object is a package, the ending point represents a delivery destination where the package is unloaded from the vehicle. Note that the standby base, the starting point, and the ending point are represented by a name, an address, coordinates on a map, or latitude and longitude of a bus stop.

When the transportation object is a traveler, the check-in date/time represents the date and time at which the traveler arrives at the bus stop which is the starting point, and when the transportation object is a package, the check-in date/time represents the date and time at which the package is carried into the warehouse which is the starting point.

In the multi-depot delivery, the same package is stored in a plurality of warehouses. For example, the third transportation object r3 exists at two starting points s3s1 and s3s2. The check-in date/time when the third transportation object r3 is carried into the starting point s3s1 is 23:00 on Feb. 28, 2023, and the check-in date/time at which the third transportation object r3 is carried into the starting point s3s2 is 20:00 on Feb. 28, 2023.

The transportation request transmitter 32 transmits, to the transportation plan creation server 1, transportation request data including a starting point for starting transportation of each of one or more transportation objects, an ending point for ending transportation of each of the one or more transportation objects, and a check-in date/time (first arrival date/time) indicating a date and time at which each of the one or more transportation objects arrives at the starting point. Specifically, the transportation request transmitter 32 transmits the transportation request data including the vehicle definition data and the transportation object definition data created by the transportation request creator 37 to the transportation plan creation server 1. The transportation request transmitter 32 periodically transmits the transportation request data to the transportation plan creation server 1. For example, at 0:00 AM, the transportation request transmitter 32 may transmit, to the transportation plan creation server 1, transportation request data in which a plurality of pieces of individual transportation request data for one day are integrated.

The transportation plan receiver 33 receives the transportation plan in which the starting point and the ending point of one or more transportation objects are arranged in time series for each of one or more vehicles, the transportation plan being transmitted by the transportation plan creation server 1.

The transportation plan creation server 1 creates the transportation plan for transporting the one or more transportation objects by the one or more vehicles. The transportation plan creation server 1 is communicably connected to the operation management server 3 via a network. The network is the Internet, for example.

Note that the transportation plan creation server 1 is a general-purpose device that receives a transportation request from a client and outputs an optimal transportation plan. The transportation plan creation server 1 can be used for both traveler transportation and package delivery. An assumed use case of traveler transportation according to the first embodiment is not real-time creation of adding a new customer to a transportation plan in operation at any time, but batch creation of creating a transportation plan on the basis of a reservation received before operation. The starting date/time of transportation is fixed to 6:00 on the day. All the transportation objects included in the transportation request have arrived by the starting date/time of transportation. That is, the check-in date/time of each transportation object is earlier than the starting date/time of transportation. Limitations on the time such as business hours of the vehicle in package delivery and traveler transportation are not handled. The time required for loading and unloading the package in the package delivery and the time required for boarding and disembarking the traveler in the traveler transportation are not counted. That is, these required times are set to 0 hours.

The transportation plan creation server 1 includes a setting data storage part 11, a transportation plan creator 12, a transportation request receiver 13, and a transportation plan transmitter 14.

The transportation plan creator 12 is implemented by a processor. The processor includes, for example, a central processing unit (CPU) or the like.

The setting data storage part 11 is implemented by a memory. The memory includes, for example, a read only memory (ROM), an electrically erasable programmable read only memory (EEPROM), or the like.

The transportation request receiver 13 and the transportation plan transmitter 14 are implemented by a communication module.

The setting data storage part 11 stores spot timetable data and inter-spot distance table data in advance.

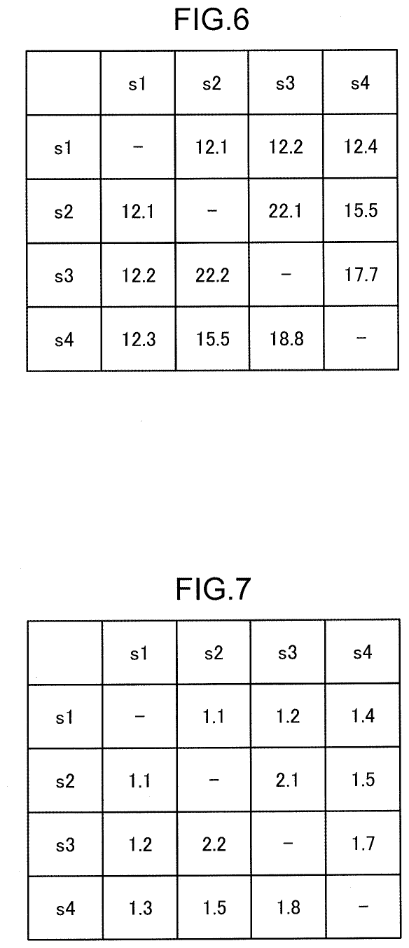

FIG. 6 is a diagram illustrating an example of the spot timetable data in the first embodiment.

The spot timetable data is data indicating time required for movement between spots (scheduled movement time). The spot represents a standby base of the vehicle, a starting point and an ending point of the transportation object, and is, for example, a standby base, a bus stop, a location of a warehouse, or a delivery destination. In the spot timetable data, the vertical axis represents spots s1, s2, s3, and s4 as movement sources, and the horizontal axis represents the spots s1, s2, s3, and s4 as movement destinations. The unit is, for example, a minute. The spot timetable data does not become a symmetric matrix due to the presence of one-way traffic, a difference in traffic volume, or the like. In the spot timetable data in the first embodiment, a fixed value is used regardless of a time period, a season, or the like, but a different value may be used for each time period or each season.

FIG. 7 is a diagram illustrating an example of the inter-spot distance table data in the first embodiment.

The inter-spot distance table data is data indicating a distance of a movement route between the spots. In the inter-spot distance table data, the vertical axis represents spots s1, s2, s3, and s4 as movement sources, and the horizontal axis represents the spots s1, s2, s3, and s4 as movement destinations. The unit is, for example, kilometers. The inter-spot distance table data does not become a symmetric matrix due to the presence of one-way traffic or the like. In the inter-spot distance table data in the first embodiment, a fixed value is used regardless of a time period, a season, or the like, but a different value may be used for each time period or each season.

The transportation request receiver 13 acquires transportation request data including a starting point for starting transportation of each of one or more transportation objects, an ending point for ending transportation of each of the one or more transportation objects, and a check-in date/time (first arrival date/time) indicating a date and time at which each of the one or more transportation objects arrives at the starting point. The transportation request receiver 13 receives the transportation request data transmitted by the operation management server 3.

Specifically, the transportation request data includes the vehicle definition data and the transportation object definition data.

The transportation plan creator 12 creates a transportation plan for transporting one or more transportation objects on the basis of a sum of one or more holding costs that correspond to a difference between a check-in date/time (first arrival date/time) and a pickup date/time (second arrival date/time) that indicates a date and time at which one or more vehicles that transport the transportation object arrive at a starting point for each of the one or more transportation objects and one or more transportation costs required for transporting the one or more transportation objects from the starting point to the ending point for each of the one or more transportation objects. The transportation cost in the first embodiment is a transportation time, but the present disclosure is not limited thereto, and may be a transportation distance. The holding cost in the first embodiment is a holding time.

The transportation plan creator 12 creates a transportation plan that defines one or more transportation objects to be transported by each of the one or more vehicles to minimize the sum of the one or more holding costs and the one or more transportation costs. The transportation plan is created by arranging the starting point and the ending point of one or more transportation objects to be transported by one or more vehicles in time series for each of the one or more vehicles.

The transportation plan includes an individual transportation plan of each of the one or more vehicles. The individual transportation plan indicates a transportation order in which pickup locations (starting points) and drop-off locations (ending points) of one or more transportation objects allocated to individual vehicles are arranged in time series. The individual transportation plan includes a pickup date/time and a drop-off date/time of each transportation object (starting point arrival date/time and ending point arrival date/time of each vehicle). A top of the individual transportation plan is a standby base of each vehicle. The standby base is a departure point of the vehicle. The transportation plan indicates a set of individual transportation plans.

The transportation plan creator 12 creates the transportation plan on the basis of the sum of one or more operation costs required for moving from a first departure point (standby base) to a last ending point of the vehicle, one or more holding costs, and one or more transportation costs for each of one or more vehicles included in the transportation plan. Note that the operation cost is an operation time, but the present disclosure is not limited thereto, and may be an operation distance. The transportation plan creator 12 creates the transportation plan to minimize a sum of the one or more operation costs, the one or more holding costs, and the one or more transportation costs.

When there is a plurality of starting point candidates for one transportation object among one or more transportation objects, the transportation plan creator 12 uses a starting point candidate having the sum that is smallest of the plurality of starting point candidates as the starting point of the one transportation object.

The transportation plan creator 12 includes an initial solution creator 121, an improved solution creator 122, and an evaluator 123.

The initial solution creator 121 allocates one or more transportation objects included in the transportation request data to the vehicle in an uppermost row in the vehicle definition data until the loading amount upper limit is reached. When the vehicle in the uppermost row reaches the loading amount upper limit, the initial solution creator 121 allocates the remaining transportation objects to the vehicle in the next row in the vehicle definition data. The initial solution creator 121 allocates the transportation objects to the vehicle until there is no transportation object in the transportation request data or until there is no vehicle in the vehicle definition data. The initial solution creator 121 creates, as an initial solution, a transportation plan for picking up and dropping off transportation objects allocated to each vehicle in the allocated order.

Specifically, the initial solution creator 121 acquires the vehicle definition data and the transportation object definition data included in the transportation request data received by the transportation request receiver 13. The initial solution creator 121 creates an initial solution of the transportation plan on the basis of the acquired vehicle definition data and the transportation object definition data.

The improved solution creator 122 improves the initial solution of the transportation plan by a procedure derived from a ruin and recreate method, which is a type of delivery plan sub-optimization algorithm. The ruin and recreate method is disclosed in, for example, a conventional literature (Gerhard Schrimpf, Johannes Schneider, Hermann Stamm-Wilbrandt, and Gunter Dueck, “Record Breaking Optimization Results Using the Ruin and Recreate Principles”, Journal of Computational Physics 159, 2000, 139-171).

Specifically, the improved solution creator 122 acquires an initial solution of the transportation plan created by the initial solution creator 121. The improved solution creator 122 outputs the initial solution of the acquired transportation plan to the evaluator 123, and acquires an evaluation value of the initial solution from the evaluator 123.

The improved solution creator 122 stores the acquired initial solution of the transportation plan and the evaluation value of the initial solution in the memory as a current solution of the transportation plan and an evaluation value of the current solution. The improved solution creator 122 creates a hypothesis solution of the transportation plan and an evaluation value of the hypothesis solution obtained by copying the current solution of the transportation plan and the evaluation value of the current solution. The improved solution creator 122 extracts starting points and ending points of a predetermined number of transportation object groups from the hypothesis solution of the transportation plan, and creates a first hypothesis solution candidate group in which pairs of the extracted starting points and ending points of the transportation object groups are inserted into a plurality of points of the hypothesis solution.

The improved solution creator 122 outputs the first hypothesis solution candidate group to the evaluator 123, and acquires an evaluation value of each of the first hypothesis solution candidate group from the evaluator 123. The improved solution creator 122 stores a first hypothesis solution candidate having a minimum evaluation value and an evaluation value of the first hypothesis solution candidate in the memory as the hypothesis solution of the transportation plan and the evaluation value of the hypothesis solution.

The improved solution creator 122 lists transportation objects having a plurality of starting points from the hypothesis solution of the transportation plan. The improved solution creator 122 lists combinations of starting points of the transportation objects included in the plurality of listed transportation objects as a starting point candidate set group. The improved solution creator 122 creates a second hypothesis solution candidate group in which each starting point candidate set included in the starting point candidate set group is inserted into the hypothesis solution.

The improved solution creator 122 outputs the second hypothesis solution candidate group to the evaluator 123, and acquires an evaluation value of each of the second hypothesis solution candidate group from the evaluator 123. The improved solution creator 122 stores the second hypothesis solution candidate having a minimum evaluation value and an evaluation value of the second hypothesis solution candidate in the memory as the hypothesis solution of the transportation plan and the evaluation value of the hypothesis solution. When the evaluation value of the hypothesis solution is smaller than the evaluation value of the current solution, the improved solution creator 122 replaces the current solution of the transportation plan and the evaluation value of the current solution with the hypothesis solution of the transportation plan and the evaluation value of the hypothesis solution.

The improved solution creator 122 creates an optimal solution of the transportation plan by repeatedly creating a hypothesis solution of the transportation plan and updating the current solution a predetermined number of times. The improved solution creator 122 repeatedly creates a hypothesis solution of the transportation plan and updates the current solution a predetermined number of times, and then outputs the current solution of the transportation plan.

The evaluator 123 acquires an initial solution of the transportation plan, a first hypothesis solution candidate, or a second hypothesis solution candidate from the improved solution creator 122. The evaluator 123 calculates a total value of the holding times of all the plurality of transportation objects in the initial solution of the transportation plan, the first hypothesis solution candidate, or the second hypothesis solution candidate. Specifically, the evaluator 123 calculates a total value RTT of the holding times on the basis of the following equation (1).

$$RTT = \sum r ∈ R RT ( r ) \qquad ( 1 )$$

In the above equation (1), RT(r) is a time obtained by subtracting the check-in date/time of a transportation object r from the pickup date/time of the transportation object r, and R represents a set of the transportation objects r included in the solution of the transportation plan. When the transportation object has a plurality of starting points, the evaluator 123 uses the check-in date/time corresponding to the starting point selected in the transportation plan.

The evaluator 123 calculates a total value of the transportation times of all the plurality of transportation objects in the initial solution of the transportation plan, the first hypothesis solution candidate, or the second hypothesis solution candidate. Specifically, the evaluator 123 calculates a total value TTT of the transportation times on the basis of the following equation (2).

$$TTT = \sum r ∈ R TT ( r ) \qquad ( 2 )$$

In the above equation (2), TT(r) is a time obtained by subtracting the pickup date/time of a transportation object r from the drop-off date/time of the transportation object r, and R represents a set of the transportation objects r included in the solution of the transportation plan.

The evaluator 123 calculates a first index value that is a sum of the total value RTT of the holding times of all the transportation objects included in the solution of the transportation plan and the total value TTT of the transportation times of all the transportation objects included in the solution of the transportation plan. Specifically, the evaluator 123 calculates a first index value F1 on the basis of the following equation (3).

$$F 1 = β * TTT + γ * RTT \qquad ( 3 )$$

In the above equation (3), TTT represents the total value of the transportation times of all the transportation objects included in the solution of the transportation plan, RTT represents the total value of the holding times of all the transportation objects included in the solution of the transportation plan, and a coefficient β and a coefficient γ are predetermined values and real numbers of 0 or more.

The evaluator 123 calculates a total value of the operation times of all the plurality of vehicles in the initial solution of the transportation plan, the first hypothesis solution candidate, or the second hypothesis solution candidate. Specifically, the evaluator 123 calculates a total value of the operation times as a second index value F2 on the basis of the following equation (4).

$$F2 = \sum v ∈ V OT ( v ) \qquad ( v )$$

In the above equation (4), OT(v) is a time obtained by subtracting the departure date/time of the departure point (standby base) of the vehicle v from the drop-off date/time of the last ending point of the vehicle v, and V represents a set of vehicles v included in the solution of the transportation plan.

The evaluator 123 calculates an evaluation value obtained by summing the first index value F1 and the second index value F2. Specifically, the evaluator 123 calculates the evaluation value on the basis of the following equation (5).

$$Evaluation value = F 1 + α * F 2 \qquad ( 5 )$$

In the above equation (5), the coefficient α is a predetermined value and is a real number of 0 or more.

The transportation plan with the smallest evaluation value is the optimal transportation plan. The improved solution creator 122 creates a transportation plan having the smallest evaluation value.

By using the coefficients α, β, and γ, it is possible to create a transportation plan in accordance with which of the operation time of the vehicle, the transportation time of the transportation object, and the holding time of the transportation object is emphasized. The coefficient α is a weight value that affects the operation time, the coefficient β is a weight value that affects the transportation time, and the coefficient γ is a weight value that affects the holding time. When reduction of the operation time is emphasized, it is sufficient to make the coefficient α relatively larger than other coefficients. When reduction of the transportation time is emphasized, it is sufficient to make the coefficient β relatively larger than other coefficients. When reduction of the holding time is emphasized, it is sufficient to make the coefficient γ relatively larger than other coefficients. As a specific example, when a bus stop is congested in transportation of travelers, or in a case where a space occupancy rate of a warehouse is tight in transportation of packages, the degree of congestion of the bus stop or the degree of tightness of the space occupancy rate can be reduced by increasing the coefficient γ to shorten a holding period.

The evaluator 123 outputs evaluation values of the initial solution, the first hypothesis solution candidate, or the second hypothesis solution candidate of the transportation plan to the improved solution creator 122.

The transportation plan transmitter 14 outputs the transportation plan created by the transportation plan creator 12. The transportation plan transmitter 14 transmits the transportation plan to the operation management server 3.

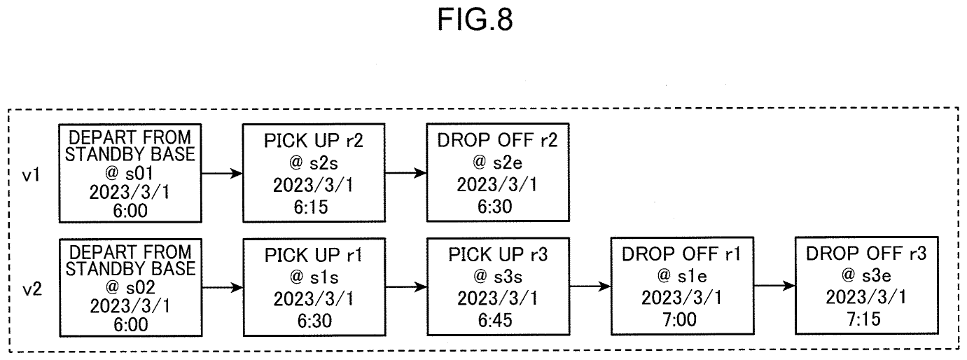

FIG. 8 is a diagram illustrating an example of the transportation plan in the first embodiment.

The individual transportation plan of the vehicle v1 departs from the standby base s01 at 6:00 on Mar. 1, 2023, picks up the second transportation object r2 at a starting point s2s at 6:15 on Mar. 1, 2023, and drops off the second transportation object r2 at an ending point s2e at 6:30 on Mar. 1, 2023. The individual transportation plan of the vehicle v2 departs from the standby base s02 at 6:00 on Mar. 1, 2023, picks up the first transportation object r1 at a starting point s1s at 6:30 on Mar. 1, 2023, picks up the third transportation object r3 at a starting point s3s at 6:45 on Mar. 1, 2023, drops off the first transportation object r1 at an ending point sle at 7:00 on Mar. 1, 2023, and drops off the third transportation object r3 at an ending point s3e at 7:15 on Mar. 1, 2023.

When receiving the transportation plan, the operation management server 3 may transmit travel schedule information indicating a travel schedule from the pickup to the drop-off of the transportation object allocated to the transportation plan to the client terminal 2. The travel schedule information includes a date and time at which the vehicle arrives at the starting point and a date and time at which the vehicle arrives at the ending point. When receiving the transportation plan, the operation management server 3 may notify the driver of the vehicle corresponding to the individual transportation plan of the individual transportation plan included in the transportation plan.

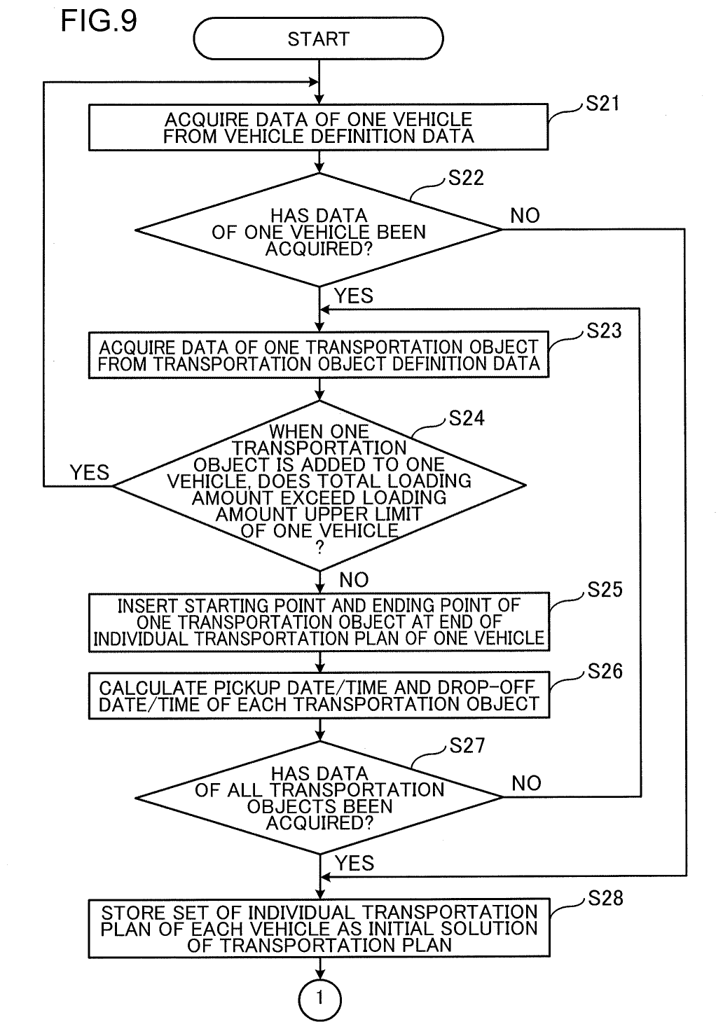

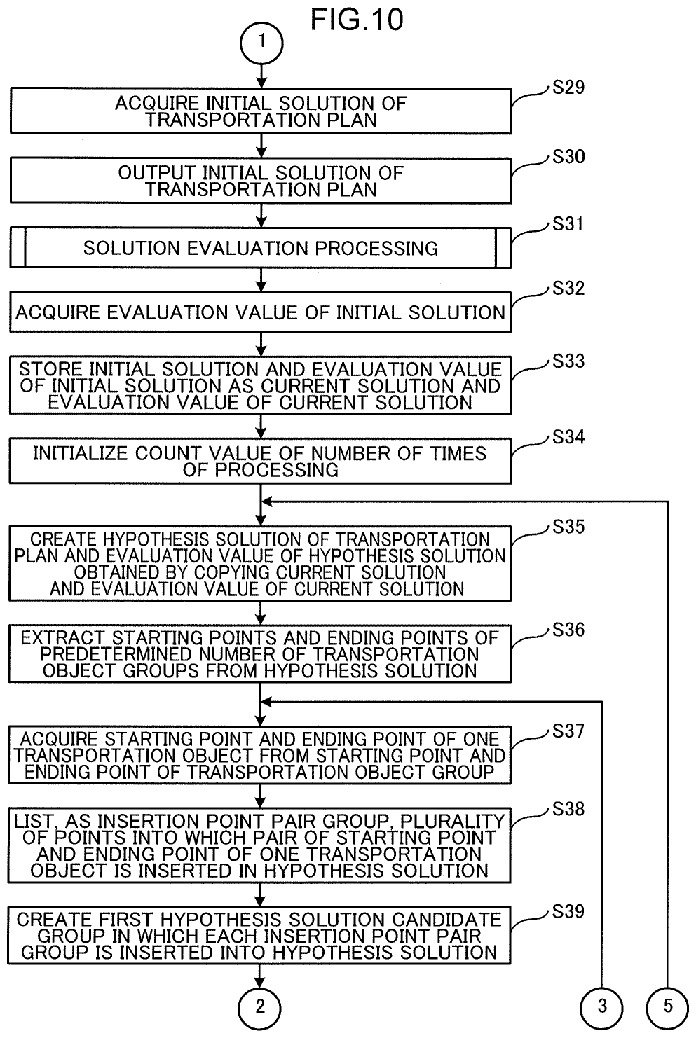

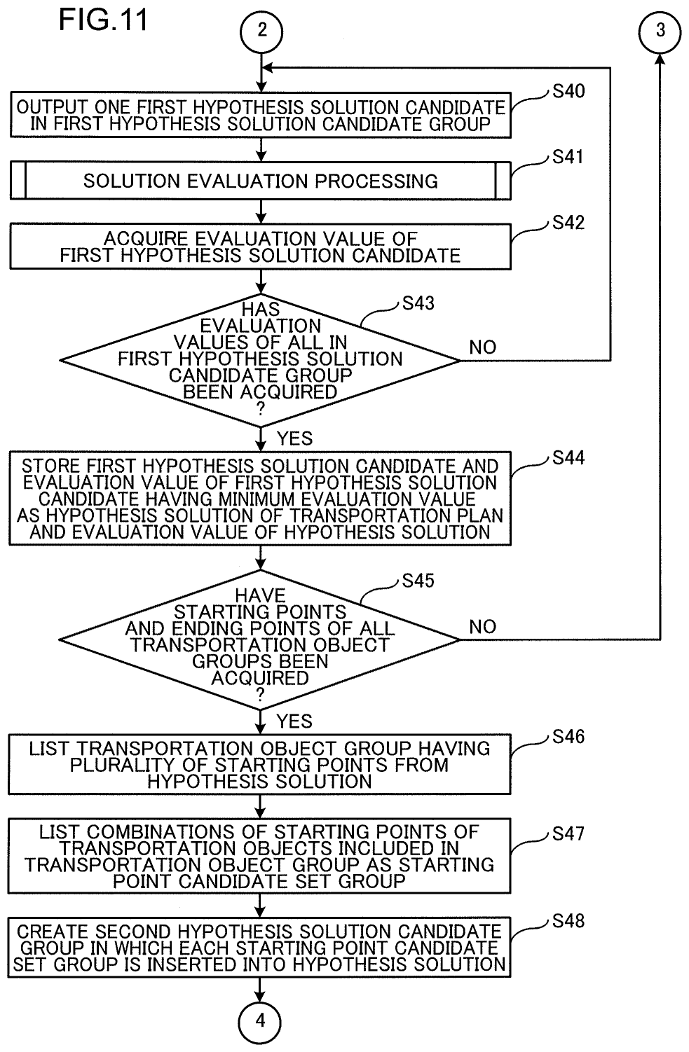

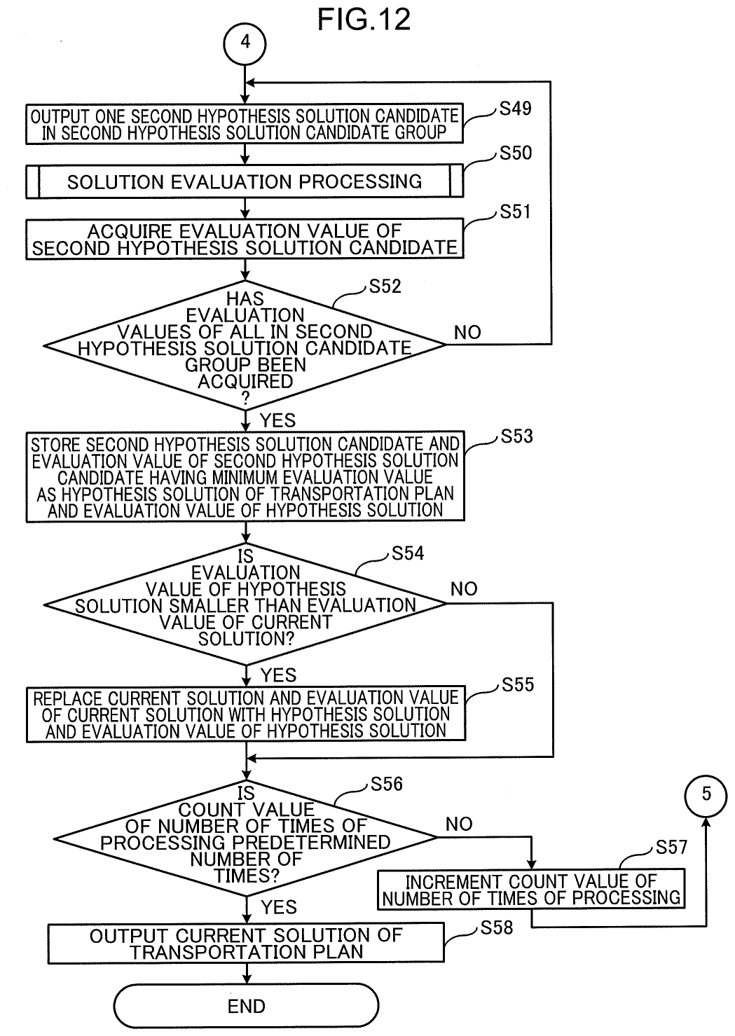

FIG. 9 is a first flowchart for describing the operation of the transportation plan creator 12 of the transportation plan creation server 1 according to the first embodiment of the present disclosure. FIG. 10 is a second flowchart for describing the operation of the transportation plan creator 12 of the transportation plan creation server 1 according to the first embodiment of the present disclosure. FIG. 11 is a third flowchart for describing the operation of the transportation plan creator 12 of the transportation plan creation server 1 according to the first embodiment of the present disclosure. FIG. 12 is a fourth flowchart for describing the operation of the transportation plan creator 12 of the transportation plan creation server 1 according to the first embodiment of the present disclosure. Note that the operations illustrated in FIGS. 9 to 12 are performed every time the transportation request data is received by the transportation request receiver 13.

First, in step S21, the initial solution creator 121 acquires data of one vehicle from the vehicle definition data included in the transportation request data received by the transportation request receiver 13. The initial solution creator 121 acquires the vehicle ID, the loading amount upper limit, and the standby base of the one vehicle from the vehicle definition data.

Next, in step S22, the initial solution creator 121 determines whether the data of the one vehicle has been acquired from the vehicle definition data. Here, when it is determined that the data of the one vehicle has not been acquired from the vehicle definition data (NO in step S22), the processing proceeds to step S28.

On the other hand, when it is determined that the data of the one vehicle has been acquired from the vehicle definition data (YES in step S22), in step S23, the initial solution creator 121 acquires data of one transportation object from the transportation object definition data included in the transportation request data received by the transportation request receiver 13. The initial solution creator 121 acquires the transportation object ID, the loading amount, the starting point, the ending point, and the check-in date/time of the one transportation object from the transportation object definition data.

Next, in step S24, when the one transportation object is added to one vehicle, the initial solution creator 121 determines whether a total loading amount exceeds the loading amount upper limit of the one vehicle. The initial solution creator 121 calculates the total loading amount obtained by adding the loading amount of the new one transportation object to the loading amount of the transportation object already allocated to the one vehicle, and determines whether the total loading amount exceeds the loading amount upper limit of the one vehicle.

Here, when it is determined that the total loading amount exceeds the loading amount upper limit of the one vehicle (YES in step S24), the processing returns to step S21. Then, the initial solution creator 121 acquires data of another one vehicle that has not been acquired from the vehicle definition data.

On the other hand, when it is determined that the total loading amount does not exceed the loading amount upper limit of the one vehicle (NO in step S24), in step S25, the initial solution creator 121 inserts the starting point and the ending point of the one transportation object at the end of the individual transportation plan of the one vehicle. When a plurality of starting points is associated with one transportation object, the initial solution creator 121 selects any of the plurality of starting points (for example, the starting point at the top).

Next, in step S26, the initial solution creator 121 calculates the pickup date/time and the drop-off date/time (starting point arrival date/time and ending point arrival date/time of each vehicle) of each transportation object on the basis of the spot timetable data. A movement time between the spots is determined in advance in the spot timetable data. Therefore, the initial solution creator 121 can calculate the pickup date/time and the drop-off date/time (the starting point arrival date/time and the ending point arrival date/time of each vehicle) of each transportation object by adding the movement time between the spots to the departure date/time of the standby base.

Next, in step S27, the initial solution creator 121 determines whether data of all the transportation objects has been acquired from the transportation object definition data. Here, when it is determined that the data of all the transportation objects has not been acquired from the transportation object definition data (NO in step S27), the processing returns to step S23. Then, the initial solution creator 121 acquires data of another one transportation object that has not yet been acquired from the transportation object definition data.

On the other hand, when it is determined that the data of all the transportation objects has been acquired from the transportation object definition data (YES in step S27), in step S28, the initial solution creator 121 stores a set of individual transportation plans of each vehicle in the memory as an initial solution of the transportation plan.

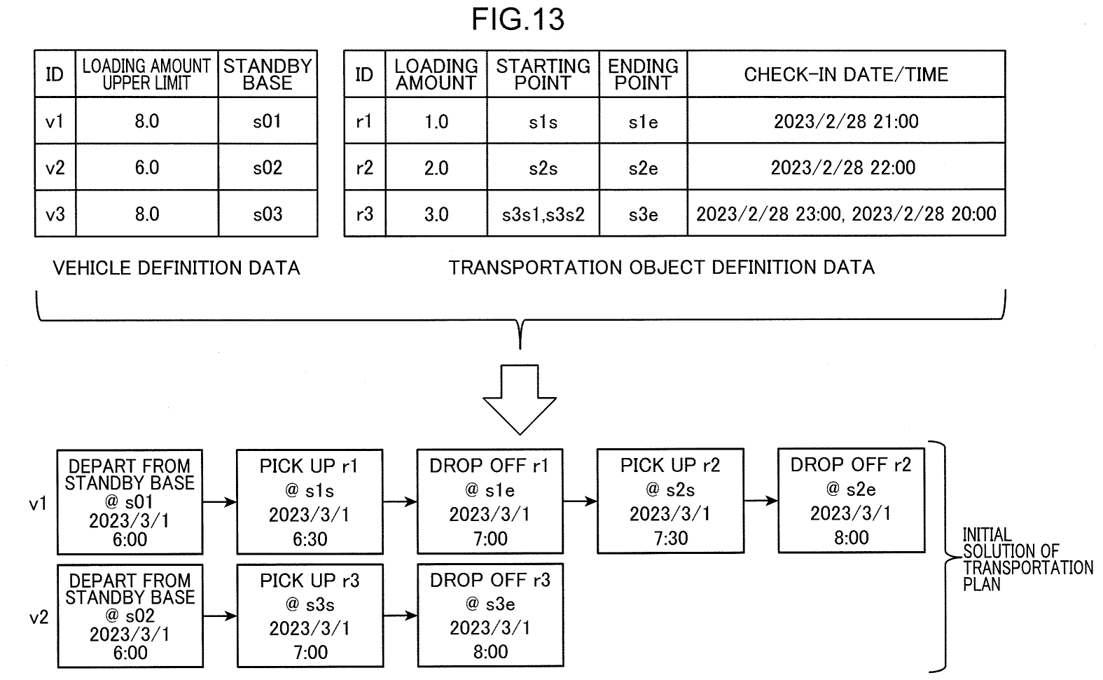

FIG. 13 is a schematic diagram for describing processing of creating the initial solution of the transportation plan by the initial solution creator 121 in the first embodiment.

The initial solution creator 121 specifies one vehicle from the vehicle definition data. Then, the initial solution creator 121 allocates each transportation object in the transportation object definition data to the specified one vehicle. At this time, the initial solution creator 121 allocates one or more transportation objects included in the transportation object definition data to the vehicle in an uppermost row in the vehicle definition data until the total loading amount of the vehicle reaches the loading amount upper limit. When the total loading amount of the vehicle reaches the loading amount upper limit, the initial solution creator 121 allocates the remaining transportation objects to the vehicle in the next row in the vehicle definition data until the total loading amount of the vehicle reaches the loading amount upper limit.

The initial solution of the transportation plan causes the allocated transportation objects to be picked up and dropped off in the allocated order. In FIG. 13, an individual transportation plan in which the transportation object r1 and the transportation object r2 are allocated to the first vehicle v1 and an individual transportation plan in which the transportation object r3 is allocated to the second vehicle v2 are created.

The individual transportation plan of the first vehicle v1 and the individual transportation plan of the second vehicle v2 are stored as the initial solution of the transportation plan. As a result, the initial solution of the transportation plan including the individual transportation plan of the first vehicle v1 and the second vehicle v2 is created.

Referring to FIG. 10 again, next, in step S29, the improved solution creator 122 acquires the initial solution of the transportation plan created by the initial solution creator 121 from the memory.

Next, in step S30, the improved solution creator 122 outputs the acquired initial solution of the transportation plan to the evaluator 123.

Next, in step S31, the evaluator 123 executes solution evaluation processing of calculating an evaluation value of the initial solution of the transportation plan created by the initial solution creator 121. Note that the solution evaluation processing will be described later.

Next, in step S32, the improved solution creator 122 acquires the evaluation value of the initial solution of the transportation plan from the evaluator 123.

Next, in step S33, the improved solution creator 122 stores the initial solution of the transportation plan created by the initial solution creator 121 and the evaluation value of the initial solution in the memory as the current solution of the transportation plan and the evaluation value of the current solution.

Next, in step S34, the improved solution creator 122 initializes a count value of the number of times of processing. That is, the improved solution creator 122 sets the count value of the number of times of processing to 0.

Next, in step S35, the improved solution creator 122 creates a hypothesis solution of the transportation plan and an evaluation value of the hypothesis solution obtained by copying the current solution of the transportation plan and the evaluation value of the current solution stored in the memory.

Next, in step S36, the improved solution creator 122 extracts starting points and ending points of a predetermined number of transportation object groups from the hypothesis solution of the transportation plan. The improved solution creator 122 randomly determines the starting points and the ending points of the transportation object groups to be extracted.

Next, in step S37, the improved solution creator 122 acquires a starting point and an ending point of one transportation object from the extracted starting points and ending points of the transportation object groups.

Next, in step S38, the improved solution creator 122 lists, as an insertion point pair group, a plurality of points into which a pair of starting points and ending points of one transportation object is inserted in the hypothesis solution of the transportation plan. The insertion point pair needs to satisfy the condition that the insertion point of the starting point belongs to the same vehicle as the ending point and is ahead of the insertion point of the ending point in the transportation plan, and the condition that the loading amount upper limit of the vehicle is not exceeded as a result of inserting the starting point and the ending point.

Next, in step S39, the improved solution creator 122 creates a first hypothesis solution candidate group in which each insertion point pair group is inserted into the hypothesis solution of the transportation plan.

Next, in step S40, the improved solution creator 122 outputs one first hypothesis solution candidate in the first hypothesis solution candidate group of the transportation plan to the evaluator 123.

Next, in step S41, the evaluator 123 executes solution evaluation processing of calculating an evaluation value of the first hypothesis solution candidate of the transportation plan created by the improved solution creator 122. Note that the solution evaluation processing will be described later.

Next, in step S42, the improved solution creator 122 acquires the evaluation value of the first hypothesis solution candidate of the transportation plan from the evaluator 123.

Next, in step S43, the improved solution creator 122 determines whether the evaluation values of all the first hypothesis solution candidates in the first hypothesis solution candidate group of the transportation plan have been acquired. Here, when it is determined that the evaluation values of all the first hypothesis solution candidates in the first hypothesis solution candidate group of the transportation plan have not been acquired (NO in step S43), the processing returns to step S40. Then, the improved solution creator 122 outputs, to the evaluator 123, another one first hypothesis solution candidate of which the evaluation value has not been acquired yet among the first hypothesis solution candidate group of the transportation plan.

On the other hand, when it is determined that the evaluation values of all the first hypothesis solution candidates in the first hypothesis solution candidate group of the transportation plan have been acquired (YES in step S43), in step S44, the improved solution creator 122 stores the first hypothesis solution candidate and the evaluation value of the first hypothesis solution candidate having a minimum evaluation value in the memory as the hypothesis solution of the transportation plan and the evaluation value of the hypothesis solution.

Next, in step S45, the improved solution creator 122 determines whether the starting points and the ending points of all the extracted transportation object groups have been acquired. Here, when it is determined that the starting points and the ending points of all the transportation object groups have not been acquired (NO in step S45), the processing returns to step S37. Then, the improved solution creator 122 acquires a starting point and an ending point of another one transportation object that has not been acquired from the extracted starting points and ending points of the transportation object groups.

On the other hand, when it is determined that the starting points and the ending points of all the transportation object groups have been acquired (YES in step S45), in step S46, the improved solution creator 122 lists the transportation objects having a plurality of starting points from the hypothesis solution of the transportation plan. The improved solution creator 122 lists a transportation object group having a plurality of starting points in the transportation object definition data from among one or more transportation objects included in the hypothesis solution of the transportation plan. When there is no transportation object having a plurality of starting points in the hypothesis solution of the transportation plan, the processing proceeds to step S54.

Next, in step S47, the improved solution creator 122 lists combinations of starting points of the transportation objects included in the transportation object group as a starting point candidate set group. For example, when there are two transportation objects having two starting points and there is one transportation object having three starting points in the hypothesis solution of the transportation plan, the number of starting point candidate set groups is 12 (=2*2*3).

Next, in step S48, the improved solution creator 122 creates a second hypothesis solution candidate group in which each starting point candidate set group is inserted into the hypothesis solution of the transportation plan. At this time, the improved solution creator 122 uses the check-in date/time corresponding to the starting point included in the starting point candidate set.

Next, in step S49, the improved solution creator 122 outputs one second hypothesis solution candidate in the second hypothesis solution candidate group of the transportation plan to the evaluator 123.

Next, in step S50, the evaluator 123 executes solution evaluation processing of calculating an evaluation value of the second hypothesis solution candidate of the transportation plan created by the improved solution creator 122. Note that the solution evaluation processing will be described later.

Next, in step S51, the improved solution creator 122 acquires the evaluation value of the second hypothesis solution candidate of the transportation plan from the evaluator 123.

Next, in step S52, the improved solution creator 122 determines whether the evaluation values of all the second hypothesis solution candidates in the second hypothesis solution candidate group of the transportation plan have been acquired. Here, when it is determined that the evaluation values of all the second hypothesis solution candidates in the second hypothesis solution candidate group of the transportation plan have not been acquired (NO in step S52), the processing returns to step S49. Then, the improved solution creator 122 outputs, to the evaluator 123, another one second hypothesis solution candidate of which the evaluation value has not been acquired yet among the second hypothesis solution candidate group of the transportation plan.

On the other hand, when it is determined that the evaluation values of all the second hypothesis solution candidates in the second hypothesis solution candidate group of the transportation plan have been acquired (YES in step S52), in step S53, the improved solution creator 122 stores the second hypothesis solution candidate and the evaluation value of the second hypothesis solution candidate having a minimum evaluation value in the memory as the hypothesis solution of the transportation plan and the evaluation value of the hypothesis solution.

Next, in step S54, the improved solution creator 122 determines whether the evaluation value of the hypothesis solution is smaller than the evaluation value of the current solution. Here, when it is determined that the evaluation value of the hypothesis solution is equal to or more than the evaluation value of the current solution (NO in step S54), the processing proceeds to step S56.

On the other hand, when it is determined that the evaluation value of the hypothesis solution is smaller than the evaluation value of the current solution (YES in step S54), in step S55, the improved solution creator 122 replaces the current solution of the transportation plan and the evaluation value of the current solution stored in the memory with the hypothesis solution of the transportation plan and the evaluation value of the hypothesis solution.

Next, in step S56, the improved solution creator 122 determines whether the count value of the number of times of processing is a predetermined number of times. Here, when it is determined that the count value of the number of times of processing is not the predetermined number of times (NO in step S56), the improved solution creator 122 increments the count value of the number of times of processing in step S57. Then, after the processing of step S57 is performed, the processing returns to step S35.

On the other hand, when it is determined that the count value of the number of times of processing is the predetermined number of times (YES in step S56), in step S58, the improved solution creator 122 outputs the current solution of the transportation plan to the transportation plan transmitter 14.

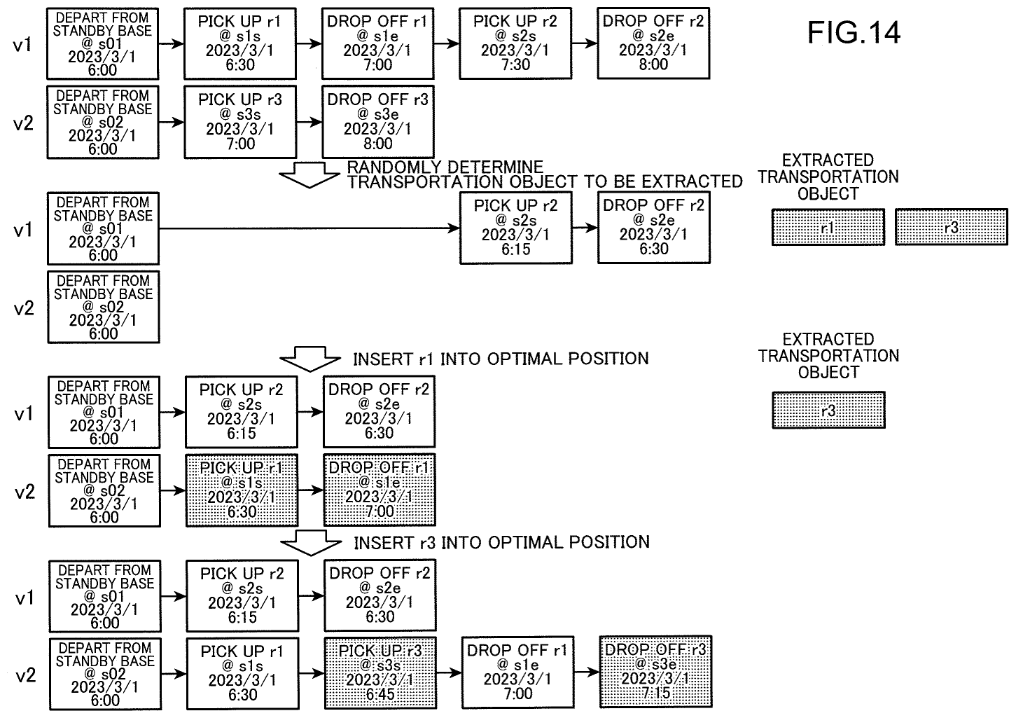

FIG. 14 is a schematic diagram for describing processing of creating the hypothesis solution of the transportation plan by the improved solution creator 122 in the first embodiment.

The improved solution creator 122 randomly determines the starting point and the ending point of a predetermined number of transportation object groups extracted from the hypothesis solution of the transportation plan, and extracts the starting point and the ending point of the transportation object group from the hypothesis solution of the transportation plan.

In FIG. 14, the starting point and the ending point of the transportation object r1 are extracted from the individual transportation plan of the first vehicle v1, and the starting point and the ending point of the transportation object r3 are extracted from the individual transportation plan of the second vehicle v2.

Finally, the improved solution creator 122 inserts the starting point and the ending point of the extracted transportation object group into the insertion point pair having the minimum evaluation value. In FIG. 14, the starting point and the ending point of the transportation object r1 are inserted into the individual transportation plan of the second vehicle v2, and then the starting point and the ending point of the transportation object r3 are inserted into the individual transportation plan of the second vehicle v2. As a result, the improved solution creator 122 creates a hypothesis solution of the transportation plan having the minimum evaluation value.

Next, details of the solution evaluation processing in step S31 in FIG. 10, step S41 in FIG. 11, and step S50 in FIG. 12 will be described.

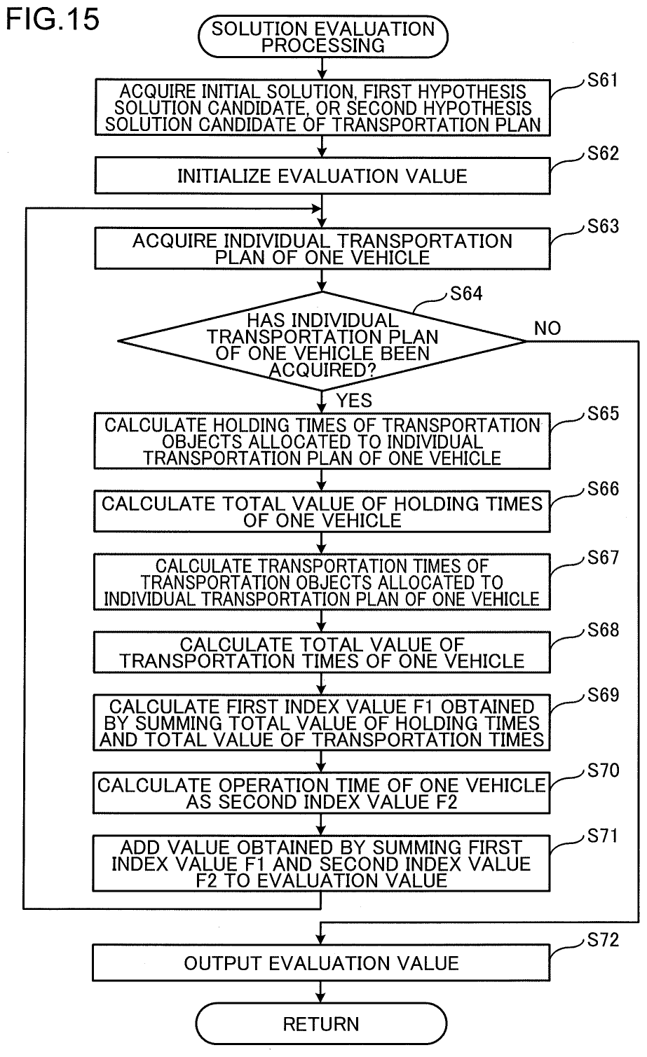

FIG. 15 is a flowchart for describing the solution evaluation processing of the transportation plan creation server 1 in the first embodiment.

First, in step S61, the evaluator 123 acquires the initial solution of the transportation plan created by the initial solution creator 121, the first hypothesis solution candidate of the transportation plan created by the improved solution creator 122, or the second hypothesis solution candidate of the transportation plan created by the improved solution creator 122. In the solution evaluation processing of step S31 in FIG. 10, the evaluator 123 acquires an initial solution of the transportation plan created by the initial solution creator 121. In the solution evaluation processing of step S41 in FIG. 11, the evaluator 123 acquires the first hypothesis solution candidate of the transportation plan created by the improved solution creator 122. In the solution evaluation processing of step S50 in FIG. 12, the evaluator 123 acquires the second hypothesis solution candidate of the transportation plan created by the improved solution creator 122.

Next, in step S62, the evaluator 123 initializes the evaluation value. That is, the evaluator 123 sets the evaluation value to 0.

Next, in step S63, the evaluator 123 acquires the individual transportation plan of one vehicle from the initial solution, the first hypothesis solution candidate, or the second hypothesis solution candidate of the transportation plan.

Next, in step S64, the evaluator 123 determines whether the individual transportation plan of one vehicle has been acquired from the initial solution, the first hypothesis solution candidate, or the second hypothesis solution candidate of the transportation plan.

Here, when it is determined that the individual transportation plan of one vehicle has been acquired (YES in step S64), in step S65, the evaluator 123 calculates the holding time of each transportation object allocated to the individual transportation plan of the one vehicle. At this time, the evaluator 123 calculates the holding time of each transportation object by subtracting the check-in date/time from the pickup date/time (the starting point arrival date/time of each vehicle) of each transportation object included in the individual transportation plan. When the transportation object is a traveler, the holding time corresponds to a standby time of the traveler from arrival of the traveler at the starting point to arrival of the vehicle that picks up the traveler at the starting point. When the transportation object is a package, the holding time corresponds to a storage time of the package from arrival of the package at the starting point (warehouse) to arrival of the vehicle that picks up the package at the starting point.

Next, in step S66, the evaluator 123 calculates a total value of the holding time of one vehicle. The evaluator 123 calculates a total value of the holding times of the transportation objects allocated to the individual transportation plan of the one vehicle.

Next, in step S67, the evaluator 123 calculates the transportation time of each transportation object allocated to the individual transportation plan of the one vehicle. At this time, the evaluator 123 calculates the transportation time of each transportation object by subtracting the pickup date/time from the drop-off date/time of each transportation object included in the individual transportation plan. When the transportation object is a traveler, the transportation time corresponds to a time during which the traveler is on board in the vehicle. When the transportation object is a package, the transportation time corresponds to a time during which the package is loaded on the vehicle.

Next, in step S68, the evaluator 123 calculates the total value of the transportation times of one vehicle. The evaluator 123 calculates a total value of the transportation times of the transportation objects allocated to the individual transportation plan of the one vehicle.

Next, in step S69, the evaluator 123 calculates the first index value F1 obtained by summing the total value of the holding times and the total value of the transportation times. At this time, the evaluator 123 calculates the first index value F1 on the basis of the above equation (3). That is, the evaluator 123 calculates the first index value F1 by summing the total value of the transportation time multiplied by the coefficient β and the total value of the holding time multiplied by the coefficient γ.

Next, in step S70, the evaluator 123 calculates the operation time of one vehicle as the second index value F2. At this time, the evaluator 123 calculates the operation time of the one vehicle by subtracting the departure date/time at the standby base at the top from the drop-off date/time at the last ending point included in the individual transportation plan of the one vehicle.

Next, in step S71, the evaluator 123 adds a sum of the first index value F1 and the second index value F2 multiplied by the coefficient α to the evaluation value. The processing returns to step S63 after the processing of step S71. Then, the processing of steps S63 to S71 is performed until the individual transportation plans of all the vehicles are acquired from the initial solution, the first hypothesis solution candidate, or the second hypothesis solution candidate of the transportation plan.

On the other hand, when it is determined that the individual transportation plan of one vehicle is not acquired from the initial solution, the first hypothesis solution candidate, or the second hypothesis solution candidate of the provisional transportation plan (NO in step S64), the evaluator 123 outputs the calculated evaluation value to the improved solution creator 122 in step S72. In the solution evaluation processing of step S31 in FIG. 10, the evaluator 123 outputs the calculated evaluation value of the initial solution to the improved solution creator 122. In the solution evaluation processing in step S41 in FIG. 11, the evaluator 123 outputs the calculated evaluation value of the first hypothesis solution candidate to the improved solution creator 122. In the solution evaluation processing in step S50 in FIG. 12, the evaluator 123 outputs the calculated evaluation value of the second hypothesis solution candidate to the improved solution creator 122.

In this manner, the transportation plan for transporting one or more transportation objects is created on the basis of the sum of the one or more holding costs that correspond to the difference between the first arrival date/time indicating the date and time at which each of the one or more transportation objects arrives at the starting point and the second arrival date/time indicating the date and time at which one or more vehicles arrive at the starting point of each of the one or more transportation objects and the one or more transportation costs required for transporting each of the one or more transportation objects from the starting point to the ending point.

Therefore, since the transportation plan is created in consideration of not only the transportation cost required for transporting the transportation object from the starting point to the ending point but also the holding cost from the arrival of the transportation object at the starting point to the arrival of the vehicle at the starting point, the holding time from the arrival of the transportation object at the starting point to the arrival of the vehicle at the starting point can be shortened.

### Second Embodiment

The transportation plan creation server according to a second embodiment changes the operation time, the transportation time, or the holding time in accordance with a transportation status of a package. Specifically, mainly for the purpose of avoiding in advance that a package is carried in exceeding a storage upper limit of the warehouse, a space occupancy rate of the warehouse is monitored, and the coefficients α, β, and γ are adjusted in accordance with the space occupancy rate.

Note that the transportation object in the second embodiment is a package.

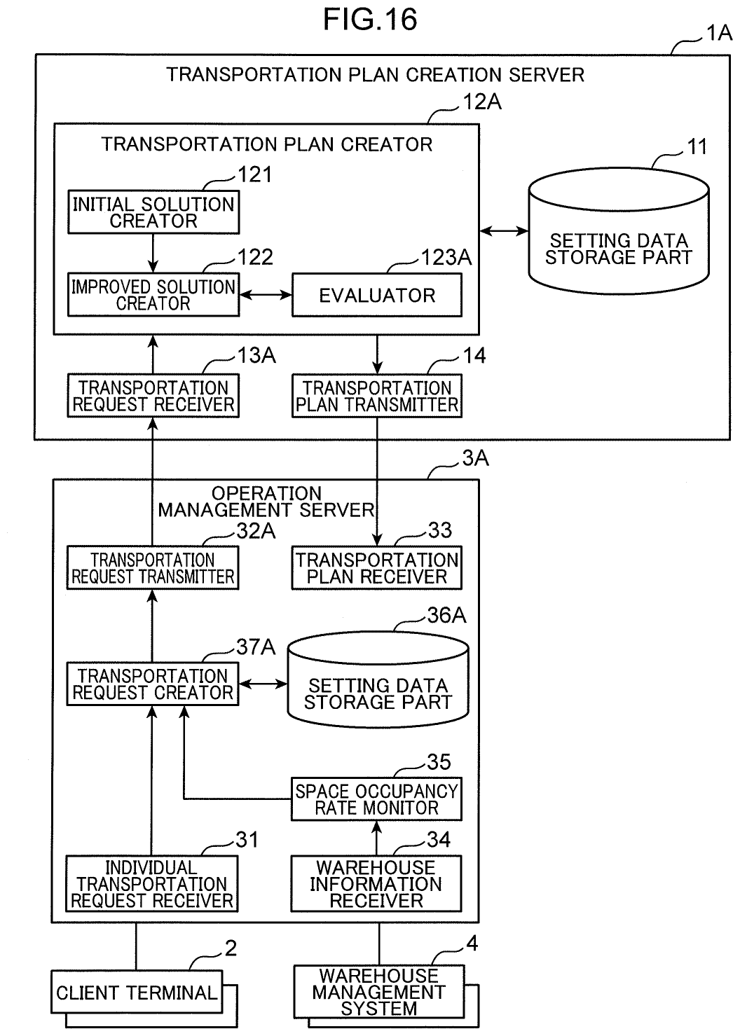

FIG. 16 is a diagram illustrating an overall configuration of the vehicle dispatch management system in the second embodiment of the present disclosure.

The vehicle dispatch management system illustrated in FIG. 16 includes a transportation plan creation server 1A, a plurality of client terminals 2, an operation management server 3A, and a plurality of warehouse management systems 4.

The warehouse management system 4 manages a storage status of a package stored in the warehouse. The warehouse management system 4 manages a current storage volume of the warehouse. The warehouse management system 4 periodically transmits the warehouse information including the current storage volume of the warehouse and a maximum storage volume of the warehouse to the operation management server 3A. The plurality of warehouse management systems 4 individually manages the plurality of warehouses. Note that one warehouse management system 4 may manage a plurality of warehouses.

The operation management server 3A includes an individual transportation request receiver 31, a transportation request transmitter 32A, a transportation plan receiver 33, a warehouse information receiver 34, a space occupancy rate monitor 35, a setting data storage part 36A, and a transportation request creator 37A. Note that, in the second embodiment, the same configuration as that in the first embodiment will be denoted by the same reference sign as that in the first embodiment, and will be omitted from description.

The warehouse information receiver 34 receives the warehouse information including the current storage volume of the warehouse and the maximum storage volume of the warehouse from the plurality of warehouse management systems 4. The warehouse information receiver 34 receives the warehouse information including the current storage volume of a warehouse that exists in the area where one or more vehicles operate and the maximum storage volume of the warehouse from the plurality of warehouse management systems 4. The warehouse information receiver 34 stores the received warehouse information in a memory (not illustrated).

The space occupancy rate monitor 35 calculates an average space occupancy rate obtained by dividing a sum of current storage volumes of one or more warehouses in which one or more packages are stored by a sum of maximum storage volumes of the one or more warehouses. The space occupancy rate monitor 35 calculates the average space occupancy rate on the basis of the following equations (6) to (8).

$$Average space occupancy rate = TotalStock / TotalCapacity \qquad ( 6 )$$

$$TotalCapacity = \sum w ∈ W Capacity ( w ) \qquad ( 7 )$$

$$TotalStock = \sum w ∈ W Stock ( w ) \qquad ( 8 )$$

In the above equations (7) and (8), Capacity(w) represents a maximum storage volume of a warehouse w, Stock(w) represents a current storage volume of the warehouse w, and W represents a set of warehouses w.

The setting data storage part 36A stores in advance coefficient setting data in which the average space occupancy rate is associated with the coefficients α, β, and γ. The setting data storage part 36A stores the vehicle definition data in advance.

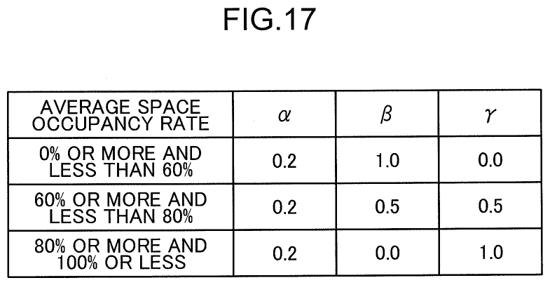

FIG. 17 is a diagram illustrating an example of the coefficient setting data in the second embodiment.

When the average space occupancy rate is equal to or more than a first threshold, the coefficient γ is larger than the coefficients α and β. When the average space occupancy rate is less than a second threshold, the coefficient β is larger than the coefficients α and γ. The first threshold is, for example, 80%, and the second threshold is, for example, 60%. In the second embodiment, the first threshold and the second threshold are different from each other, but the present disclosure is not limited thereto, and the first threshold and the second threshold may be the same.

As illustrated in FIG. 17, when the average space occupancy rate is 80% or more and 100% or less, the coefficient α is 0.2, the coefficient β is 0.0, and the coefficient γ is 1.0. When the average space occupancy rate is 60% or more and less than 80%, the coefficient α is 0.2, the coefficient β is 0.5, and the coefficient γ is 0.5. When the average space occupancy rate is 0% or more and less than 60%, the coefficient α is 0.2, the coefficient β is 1.0, and the coefficient γ is 0.0.

The transportation request creator 37A acquires the vehicle definition data from the setting data storage part 36A. The transportation request creator 37A creates the transportation object definition data on the basis of the individual transportation request data received by the individual transportation request receiver 31. The transportation request creator 37A refers to the coefficient setting data, and determines the coefficient α, the coefficient β, and the coefficient γ corresponding to the average space occupancy rate calculated by the space occupancy rate monitor 35. The transportation request creator 37A creates transportation request data including the vehicle definition data, the transportation object definition data, and the values of the coefficient α, the coefficient β, and the coefficient γ.

The transportation request transmitter 32A transmits the transportation request data created by the transportation request creator 37A to the transportation plan creation server 1A.

The transportation plan creation server 1A includes a setting data storage part 11, a transportation plan creator 12A, a transportation request receiver 13A, and a transportation plan transmitter 14.

The transportation request receiver 13A receives transportation request data including the vehicle definition data, the transportation object definition data, and the values of the coefficient α, the coefficient, and the coefficient γ from the operation management server 3A.

The transportation plan creator 12A creates the transportation plan such that one of the holding cost or the transportation cost is smaller than another one of the holding cost or the transportation cost on the basis of the average space occupancy rate obtained by dividing the sum of the current storage volumes of one or more warehouses in which one or more packages are stored by the sum of the maximum storage volumes of the one or more warehouses. The transportation plan creator 12A creates the transportation plan so that the holding cost is smaller than the transportation cost when the average space occupancy rate is equal to or more than the first threshold, and creates the transportation plan so that the transportation cost is smaller than the holding cost when the average space occupancy rate is less than the second threshold. The second threshold is smaller than the first threshold. The holding cost in the second embodiment is a holding time.

When the average space occupancy rate is equal to or more than the first threshold, the coefficient γ is larger than the coefficients α and β, and thus, the transportation plan creator 12A creates the transportation plan so that the holding time is shorter than the transportation time and the operation time. When the average space occupancy rate is less than the second threshold which is smaller than the first threshold, the coefficient β is larger than the coefficients α and γ, and thus, the transportation plan creator 12A creates the transportation plan so that the transportation time is shorter than the holding time and the operation time.

The transportation plan creator 12A includes an initial solution creator 121, an improved solution creator 122, and an evaluator 123A.

The evaluator 123A calculates an evaluation value using the coefficient α, the coefficient β, and the coefficient γ included in the transportation request data received by the transportation request receiver 13A.

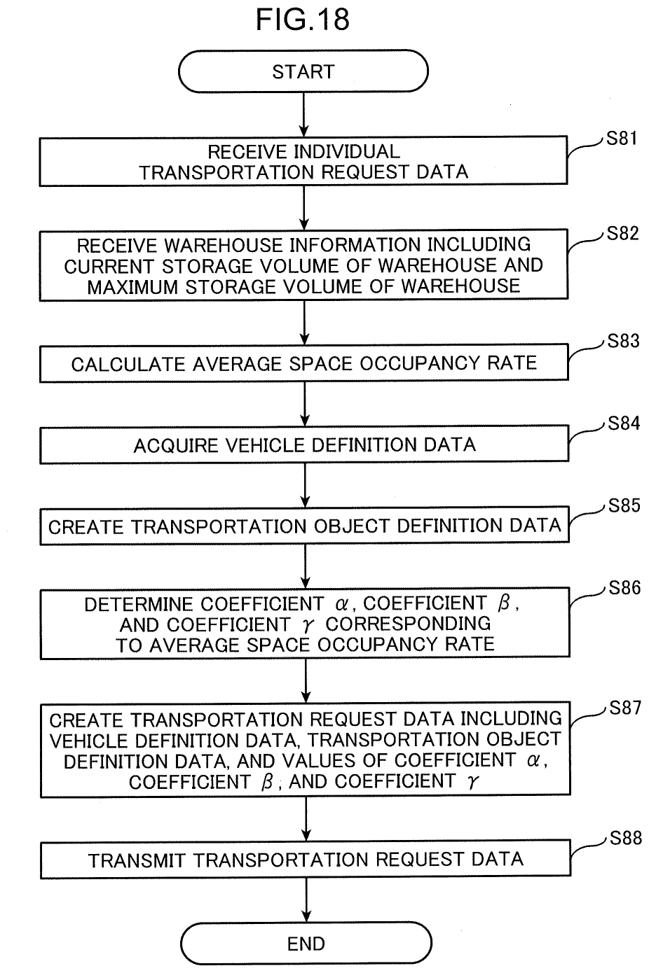

FIG. 18 is a flowchart for describing an operation of the operation management server 3A in the second embodiment of the present disclosure.

First, in step S81, the individual transportation request receiver 31 receives the individual transportation request data transmitted by each of the plurality of client terminals 2.

Next, in step S82, the warehouse information receiver 34 receives the warehouse information including the current storage volume of the warehouse and the maximum storage volume of the warehouse transmitted by each of the plurality of warehouse management systems 4.

Then, in step S83, the space occupancy rate monitor 35 calculates an average space occupancy rate obtained by dividing a sum of current storage volumes of one or more warehouses in which one or more packages are stored by a sum of maximum storage volumes of the one or more warehouses.

Next, in step S84, the transportation request creator 37A acquires the vehicle definition data from the setting data storage part 36A.

Next, in step S85, the transportation request creator 37A creates the transportation object definition data on the basis of the individual transportation request data received by the individual transportation request receiver 31.

Next, in step S86, the transportation request creator 37A refers to the coefficient setting data, and determines the coefficient α, the coefficient β, and the coefficient γ corresponding to the average space occupancy rate calculated by the space occupancy rate monitor 35.

Next, in step S87, the transportation request creator 37A creates transportation request data including the vehicle definition data, the transportation object definition data, and the values of the coefficient α, the coefficient β, and the coefficient γ. The transportation request creator 37A acquires the vehicle definition data from the setting data storage part 36A. The transportation request creator 37A creates the transportation object definition data on the basis of the individual transportation request data received by the individual transportation request receiver 31.

Next, in step S88, the transportation request transmitter 32A transmits the transportation request data created by the transportation request creator 37A to the transportation plan creation server 1A.

In this manner, when the average space occupancy rate of one or more warehouses is high, the transportation plan is created so that the holding time is shorter than the transportation time and the operation time. Therefore, by shortening the holding time, the average space occupancy rate of one or more warehouses can be reduced, and it is possible to prevent a package from being carried in exceeding the storage upper limit of the entire one or more warehouses.

When the space occupancy rate of the warehouse is low, the transportation plan is created so that the transportation time is shorter than the holding time and the operation time. Therefore, by shortening the transportation time, the package can be delivered to the delivery destination more quickly.

### Third Embodiment

The transportation plan creation server according to a third embodiment changes the operation time, the transportation time, or the holding time in accordance with a transportation status of a traveler. Specifically, mainly for the purpose of avoiding excessive congestion at a bus stop in advance, the number of travelers standing by at the bus stop is monitored, and the coefficients α, β, and γ are adjusted in accordance with the number of travelers.

Note that the transportation object in the third embodiment is a traveler.

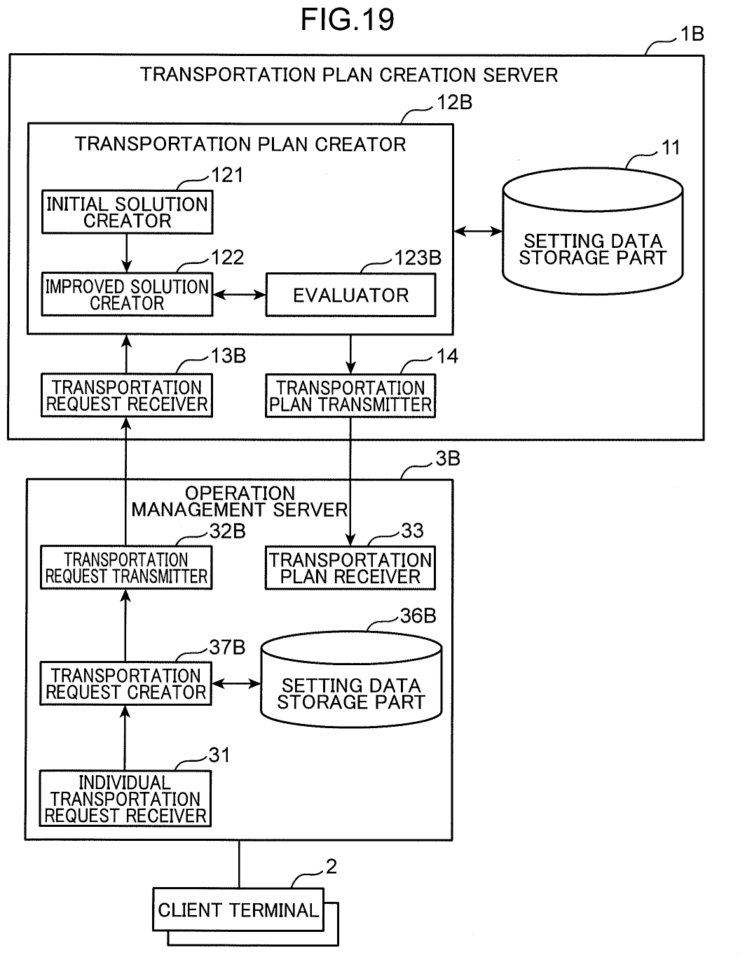

FIG. 19 is a diagram illustrating an overall configuration of the vehicle dispatch management system in the third embodiment of the present disclosure.

The vehicle dispatch management system illustrated in FIG. 19 includes a transportation plan creation server 1B, a plurality of client terminals 2, and an operation management server 3B.

The operation management server 3B includes an individual transportation request receiver 31, a transportation request transmitter 32B, a transportation plan receiver 33, a setting data storage part 36B, and a transportation request creator 37B. In the third embodiment, the same components as those in the first and second embodiments will be denoted by the same reference signs as those in the first and second embodiments, and description thereof will be omitted.

The setting data storage part 36B stores in advance coefficient setting data in which a total number of passengers for one reserved day is associated with the coefficients α, β, and γ. The setting data storage part 36B stores the vehicle definition data in advance. The total number of passengers indicates the total number of one or more travelers scheduled to board the vehicle.

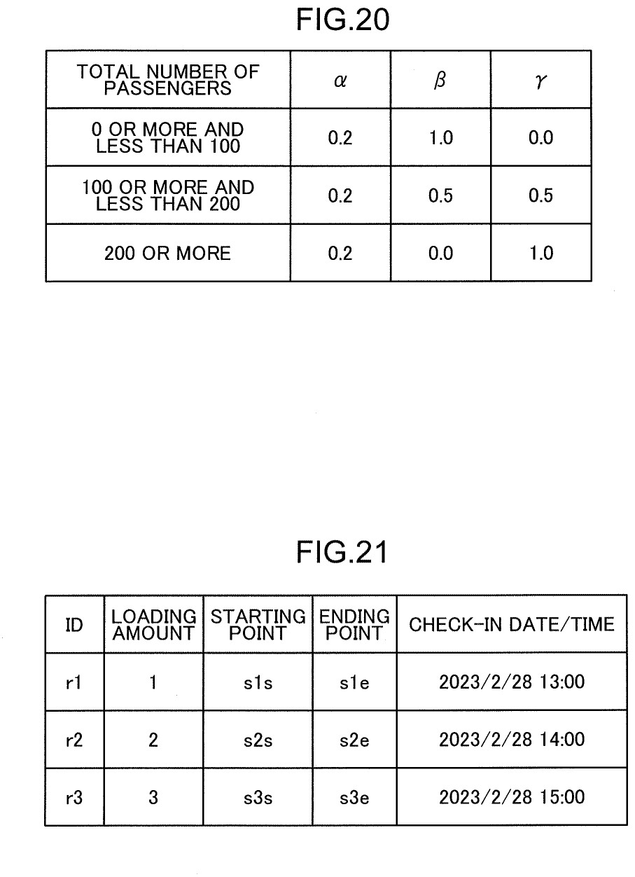

FIG. 20 is a diagram illustrating an example of the coefficient setting data in the third embodiment.

When the total number of passengers is equal to or more than a first threshold, the coefficient γ is larger than the coefficients α and β. When the total number of passengers is less than a second threshold, the coefficient β is larger than the coefficients α and γ. The first threshold is, for example, 200, and the second threshold is, for example, 100. In the third embodiment, the first threshold and the second threshold are different from each other, but the present disclosure is not limited thereto, and the first threshold and the second threshold may be the same.

As illustrated in FIG. 20, when the total number of passengers is 200 or more, the coefficient α is 0.2, the coefficient β is 0.0, and the coefficient γ is 1.0. When the total number of passengers is 100 or more and less than 200, the coefficient α is 0.2, the coefficient β is 0.5, and the coefficient γ is 0.5. When the total number of passengers is 0 or more and less than 100, the coefficient α is 0.2, the coefficient β is 1.0, and the coefficient γ is 0.0.

The transportation request creator 37B acquires the vehicle definition data from the setting data storage part 36B. The transportation request creator 37B creates the transportation object definition data on the basis of the individual transportation request data received by the individual transportation request receiver 31. The transportation request creator 37B calculates the total number of passengers on the basis of the transportation object definition data. The transportation request creator 37B calculates the total number of passengers by summing the loading amount (the number of passengers) included in the transportation object definition data. The transportation request creator 37B calculates the total number of passengers on the basis of the following equation (9).

$$Total number of passengers = \sum r ∈ R PassengerNumber ( r ) \qquad ( 9 )$$

In the above equation (9), PassengerNumber(r) represents the number of travelers in a boarding reservation r, and R represents a set of the boarding reservation r.

The transportation request creator 37B refers to the coefficient setting data, and determines the coefficient α, the coefficient β, and the coefficient γ corresponding to the calculated total number of passengers. The transportation request creator 37B creates transportation request data including the vehicle definition data, the transportation object definition data, and the values of the coefficient α, the coefficient β, and the coefficient γ.

FIG. 21 is a diagram illustrating an example of the transportation object definition data in the third embodiment.

The transportation object definition data is data indicating the transportation object ID for identifying each of one or more transportation objects, the loading amount of each of the one or more transportation objects, the starting point for starting transportation of each of the one or more transportation objects, the ending point for ending transportation of each of the one or more transportation objects, and the check-in date/time (first arrival date/time) indicating a date and time at which each of the one or more transportation objects arrives at the starting point. As illustrated in FIG. 21, in the third embodiment, the transportation object definition data includes three transportation object IDs of a first transportation object r1, a second transportation object r2, and a third transportation object r3.

In the third embodiment, the loading amount represents the number of travelers who board the vehicle, the starting point represents a bus stop where the travelers board the vehicle, the ending point represents a bus stop where the travelers board the vehicle, and the check-in date/time represents a date and time at which the travelers arrive at the bus stop that is the starting point.

The transportation request transmitter 32B transmits the transportation request data created by the transportation request creator 37B to the transportation plan creation server 1B.

The transportation plan creation server 1B includes a setting data storage part 11, a transportation plan creator 12B, a transportation request receiver 13B, and a transportation plan transmitter 14.

The transportation request receiver 13B receives transportation request data including the vehicle definition data, the transportation object definition data, and the values of the coefficient α, the coefficient, and the coefficient γ from the operation management server 3B.

The transportation plan creator 12B creates a transportation plan so that one of the holding cost or the transportation cost is smaller than another one of the holding cost or the transportation cost on the basis of the total number of passengers (the number of the one or more travelers) included in the transportation request data. The transportation plan creator 12B creates the transportation plan so that the holding cost is smaller than the transportation cost when the total number of passengers (the number of the one or more travelers) is equal to or more than the first threshold, and creates the transportation plan so that the transportation cost is smaller than the holding cost when the total number of passengers (the number of the one or more travelers) is less than the second threshold. The second threshold is smaller than the first threshold. The holding cost in the third embodiment is a holding time.

When the total number of passengers is equal to or more than the first threshold, the coefficient γ is larger than the coefficients α and β, and thus, the transportation plan creator 12B creates the transportation plan so that the holding time is shorter than the transportation time and the operation time. When the total number of passengers is less than the second threshold which is smaller than the first threshold, the coefficient β is larger than the coefficients α and γ, and thus, the transportation plan creator 12B creates the transportation plan so that the transportation time is shorter than the holding time and the operation time.

The transportation plan creator 12B includes an initial solution creator 121, an improved solution creator 122, and an evaluator 123B.

The evaluator 123B calculates an evaluation value using the coefficient α, the coefficient β, and the coefficient γ included in the transportation request data received by the transportation request receiver 13B.

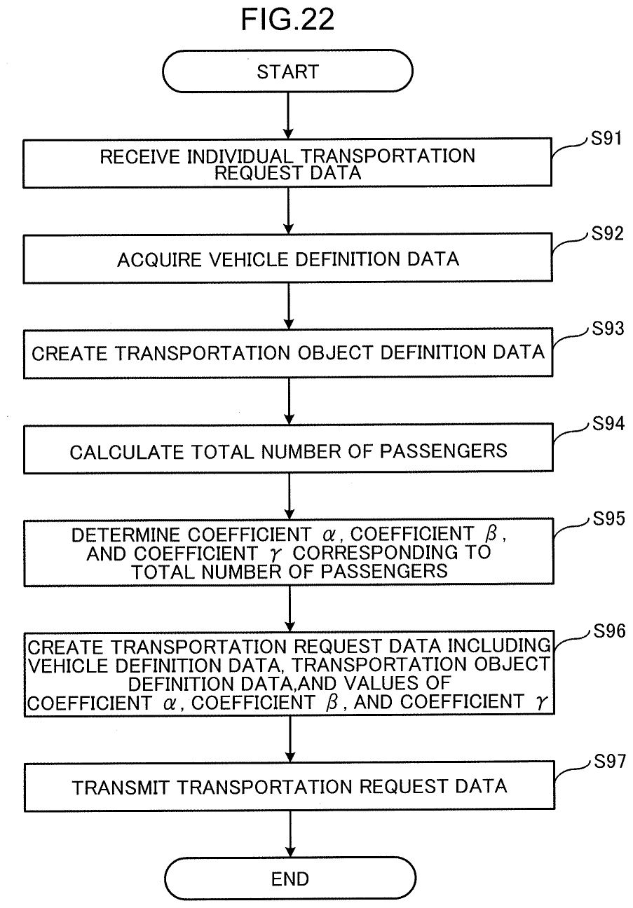

FIG. 22 is a flowchart for describing an operation of the operation management server 3B in the third embodiment of the present disclosure.

First, in step S91, the individual transportation request receiver 31 receives the individual transportation request data transmitted by each of the plurality of client terminals 2.

Next, in step S92, the transportation request creator 37B acquires the vehicle definition data from the setting data storage part 36B.

Next, in step S93, the transportation request creator 37B creates the transportation object definition data on the basis of the individual transportation request data received by the individual transportation request receiver 31.

Next, in step S94, the transportation request creator 37B calculates the total number of passengers by summing the loading amount (the number of passengers) included in the created transportation object definition data.

Next, in step S95, the transportation request creator 37B refers to the coefficient setting data, and determines the coefficient α, the coefficient, and the coefficient γ corresponding to the calculated total number of passengers.

Next, in step S96, the transportation request creator 37B creates transportation request data including the vehicle definition data, the transportation object definition data, and the values of the coefficient α, the coefficient β, and the coefficient γ.

Next, in step S97, the transportation request transmitter 32B transmits the transportation request data created by the transportation request creator 37B to the transportation plan creation server 1B.

In this manner, when the total number of passengers in one day is large and the bus stop that is the starting point is congested, the transportation plan is created so that the holding time is shorter than the transportation time and the operation time. Therefore, by shortening the holding time, travelers standing by at the bus stop that is the starting point can be reduced, and the bus stop that is the starting point can be prevented from being congested.

When the total number of passengers in one day is small and the bus stop that is the starting point is not congested, the transportation plan is created so that the transportation time is shorter than the holding time and the operation time. Therefore, by shortening the transportation time, the travelers can be delivered to the ending point more quickly.

In the third embodiment, the transportation plan is created in accordance with the total number of passengers in one day, but the transportation plan may be created in accordance with the total number of passengers in an arbitrary period of one day. The arbitrary period in one day may be set to, for example, early morning (6:00 to 9:00), morning (9:00 to 12:00), afternoon (12:00 to 15:00), evening (15:00 to 18:00), or night (18:00 to 21:00), or may be set to every hour. As a result, the total number of passengers for each time period is reflected, and it is possible to create a transportation plan more in accordance with the actual situation.

Instead of the total number of passengers, a starting point number of passengers for each starting point in one day or any period of one day may be used. Here, the starting point number of passengers is the total number of passengers at each starting point of one or more travelers scheduled to board the vehicle. In this case, the coefficient α, the coefficient β, and the coefficient γ corresponding to the starting point number of passengers for each starting point are set. For example, when the number of starting points at which the starting point number of passengers is equal to or larger than a third threshold is equal to or larger than a fourth threshold, the coefficient γ is set to be larger than the coefficients α and β. When the number of starting points at which the starting point number of passengers is equal to or larger than the third threshold is less than the fourth threshold, the coefficient β is set to be larger than the coefficients α and γ. The third threshold is, for example, ten, and the fourth threshold is, for example, five. In this manner, by using the starting point number of passengers for each starting point instead of the total number of passengers, even when travelers are concentrated and congested at specific several starting points although the total number of passengers is small, a transportation plan can be created so that the holding time is shorter than the transportation time and the operation time, and congestion at a bus stop can be prevented.

### Fourth Embodiment

The transportation plan creation server according to a fourth embodiment changes the operation time, the transportation time, or the holding time in accordance with an expiration date of a package. Specifically, for the purpose of mainly keeping freshness of a package, a grace period from a date and time at which the package arrives at a starting point to an expiration date (for example, a consumption expiration date, a best-before date, or the like) of the package is calculated, and the coefficients α, β, and γ are adjusted in accordance with the grace period.

Note that the transportation object in the fourth embodiment is a package.

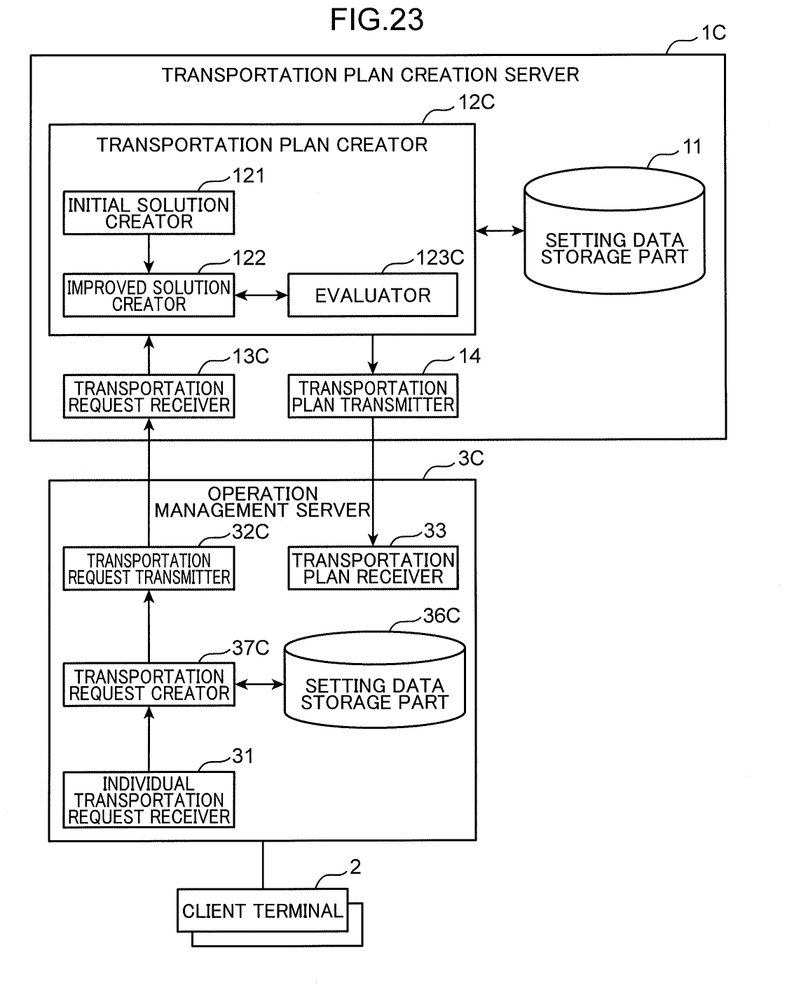

FIG. 23 is a diagram illustrating an overall configuration of the vehicle dispatch management system in the fourth embodiment of the present disclosure.

The vehicle dispatch management system illustrated in FIG. 23 includes a transportation plan creation server 1C, a plurality of client terminals 2, and an operation management server 3C.

The client terminal 2 according to the fourth embodiment accepts inputs of a transportation object amount, a starting point, an ending point, a check-in date/time (first arrival date/time), and an expiration date of a package by a client. The client terminal 2 transmits individual transportation request data including a transportation object ID, the transportation object amount, the starting point, the ending point, the check-in date/time, and the expiration date to the operation management server 3C. The expiration date in the fourth embodiment is a consumption expiration date, but the present disclosure is not limited thereto, and may be a best-before date or a predetermined date set by the client.

The operation management server 3C includes an individual transportation request receiver 31, a transportation request transmitter 32C, a transportation plan receiver 33, a setting data storage part 36C, and a transportation request creator 37C. In the fourth embodiment, the same components as those in the first to third embodiments will be denoted by the same reference signs as those in the first to third embodiments, and description thereof will be omitted.

The setting data storage part 36C stores in advance coefficient setting data in which an average grace period for one reserved day is associated with the coefficients α, β, and γ. The setting data storage part 36C stores the vehicle definition data in advance. The average grace period indicates a period obtained by dividing a sum of one or more grace periods from the starting point arrival date/time of one or more packages scheduled to be loaded on the vehicle to the expiration date of each of the one or more packages by the number of the one or more packages.

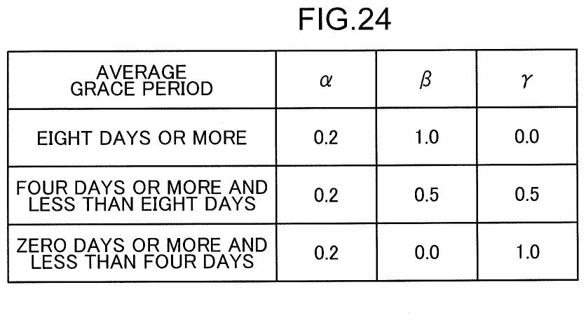

FIG. 24 is a diagram illustrating an example of the coefficient setting data in the fourth embodiment.

When the average grace period is less than a first threshold, the coefficient γ is larger than the coefficients α and β. When the average grace period is equal to or more than a second threshold, the coefficient β is larger than the coefficients α and γ. The first threshold is, for example, four days, and the second threshold is, for example, eight days. In the fourth embodiment, the first threshold and the second threshold are different from each other, but the present disclosure is not limited thereto, and the first threshold and the second threshold may be the same.

As illustrated in FIG. 24, when the average grace period is less than four days, the coefficient α is 0.2, the coefficient β is 0.0, and the coefficient γ is 1.0. When the average grace period is four days or more and less than eight days, the coefficient α is 0.2, the coefficient β is 0.5, and the coefficient γ is 0.5. When the average grace period is eight days or more, the coefficient α is 0.2, the coefficient β is 1.0, and the coefficient γ is 0.0.

The transportation request creator 37C acquires the vehicle definition data from the setting data storage part 36C. The transportation request creator 37C creates the transportation object definition data on the basis of the individual transportation request data received by the individual transportation request receiver 31.

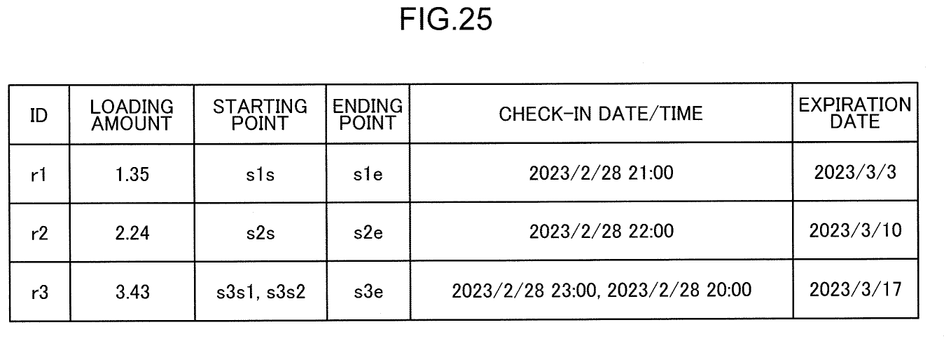

FIG. 25 is a diagram illustrating an example of the transportation object definition data in the fourth embodiment.

The transportation object definition data is data indicating the transportation object ID for identifying each of one or more transportation objects, the loading amount of each of the one or more transportation objects, the starting point for starting transportation of each of the one or more transportation objects, the ending point for ending transportation of each of the one or more transportation objects, the check-in date/time (first arrival date/time) indicating a date and time at which each of the one or more transportation objects arrives at the starting point, and the expiration date of each of the one or more transportation objects. As illustrated in FIG. 25, in the fourth embodiment, the transportation object definition data includes three transportation object IDs of a first transportation object r1, a second transportation object r2, and a third transportation object r3.

The loading amount represents the weight or the volume of the package to be loaded on the vehicle, the starting point represents a warehouse where the package is loaded on the vehicle, and the ending point represents a delivery destination where the package is unloaded from the vehicle. The check-in date/time indicates the date and time at which the package is carried into the warehouse that is the starting point. The expiration date represents the consumption expiration date of the package.

On the basis of the transportation object definition data, the transportation request creator 37C calculates the average grace period obtained by dividing a sum of one or more grace periods from the check-in date/time (first arrival date/time) of each of one or more packages to the expiration date of each of the one or more packages by the number of the one or more packages. The transportation request creator 37C calculates the average grace period on the basis of the following equation (10).

$$Average grace period = \sum r = R Available ( r ) / \vert R \vert \qquad ( 10 )$$

In the above equation (10), Available(r) represents a grace period from the check-in date/time of the package r to the expiration date, and R represents a set of packages r.

The transportation request creator 37C refers to the coefficient setting data, and determines the coefficient α, the coefficient β, and the coefficient γ corresponding to the calculated average grace period. The transportation request creator 37C creates transportation request data including the vehicle definition data, the transportation object definition data, and the values of the coefficient α, the coefficient β, and the coefficient γ.

The transportation request transmitter 32C transmits the transportation request data created by the transportation request creator 37C to the transportation plan creation server 1C.

The transportation plan creation server 1C includes a setting data storage part 11, a transportation plan creator 12C, a transportation request receiver 13C, and a transportation plan transmitter 14.

The transportation request receiver 13C receives transportation request data including the vehicle definition data, the transportation object definition data, and the values of the coefficient α, the coefficient β, and the coefficient γ from the operation management server 3C.

The transportation plan creator 12C creates the transportation plan so that one of the holding cost or the transportation cost is smaller than another one of the holding cost or the transportation cost on the basis of the average grace period obtained by dividing the sum of one or more grace periods from the check-in date/time (first arrival date/time) of each of one or more packages to the expiration date of each of the one or more packages by the number of the one or more packages. The transportation plan creator 12C creates the transportation plan so that the holding cost is smaller than the transportation cost when the average grace period is less than the first threshold, and creates the transportation plan so that the transportation cost is smaller than the holding cost when the average grace period is equal to or more than the second threshold. The second threshold is more than the first threshold. The holding cost in the fourth embodiment is a holding time.

When the average grace period is less than the first threshold, the coefficient γ is larger than the coefficients α and β, and thus, the transportation plan creator 12C creates the transportation plan so that the holding time is shorter than the transportation time and the operation time. When the average grace period is equal to or more than the second threshold which is more than the first threshold, the coefficient β is larger than the coefficients α and γ, and thus, the transportation plan creator 12C creates the transportation plan so that the transportation time is shorter than the holding time and the operation time.

The transportation plan creator 12C includes an initial solution creator 121, an improved solution creator 122, and an evaluator 123C.

The evaluator 123C calculates an evaluation value using the coefficient α, the coefficient β, and the coefficient γ included in the transportation request data received by the transportation request receiver 13C.

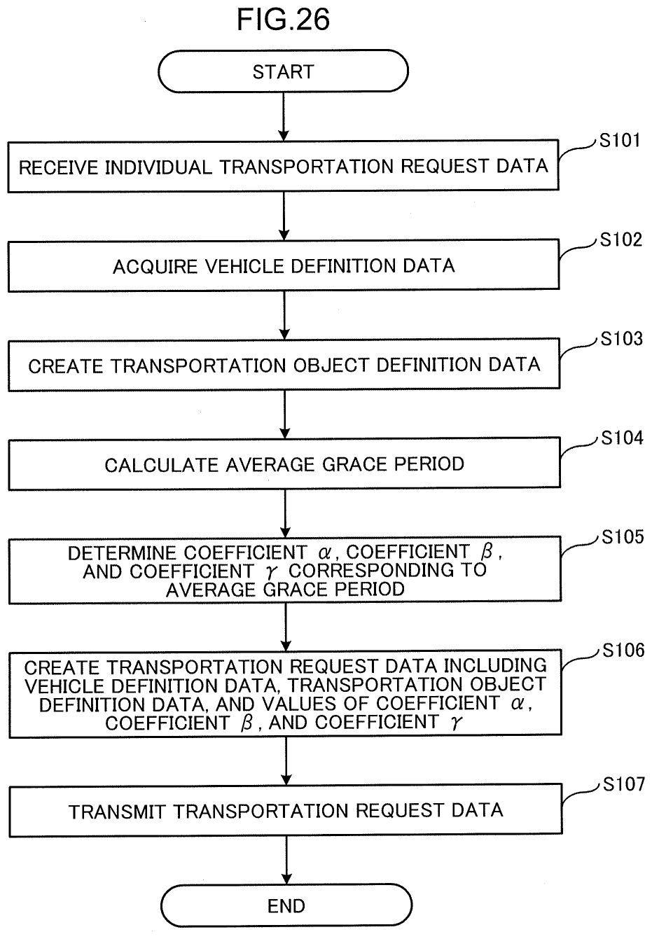

FIG. 26 is a flowchart for describing an operation of the operation management server 3C in the fourth embodiment of the present disclosure.

First, in step S101, the individual transportation request receiver 31 receives the individual transportation request data transmitted by each of the plurality of client terminals 2.

Next, in step S102, the transportation request creator 37C acquires the vehicle definition data from the setting data storage part 36C.

Next, in step S103, the transportation request creator 37C creates the transportation object definition data on the basis of the individual transportation request data received by the individual transportation request receiver 31.

Next, in step S104, the transportation request creator 37C calculates an average grace period obtained by dividing a sum of one or more grace periods from the check-in date/time (first arrival date/time) of each of one or more packages to the expiration date of each of the one or more packages by the number of the one or more packages. Here, the transportation request creator 37C acquires the check-in date/time and the expiration date of each of one or more packages included in the created transportation object definition data. Then, the transportation request creator 37C calculates the grace period from the check-in date/time to the expiration date for each of the one or more packages. Then, the transportation request creator 37C calculates an average grace period obtained by dividing the sum of the calculated grace periods of the one or more packages by the number of the one or more packages.

Next, in step S105, the transportation request creator 37C refers to the coefficient setting data, and determines the coefficient α, the coefficient, and the coefficient γ corresponding to the calculated average grace period.

Next, in step S106, the transportation request creator 37C creates transportation request data including the vehicle definition data, the transportation object definition data, and the values of the coefficient α, the coefficient β, and the coefficient γ.

Next, in step S107, the transportation request transmitter 32C transmits the transportation request data created by the transportation request creator 37C to the transportation plan creation server 1C.

In this manner, when the grace period from the check-in date/time of the package to the expiration date is short, the transportation plan is created so that the holding time is shorter than the transportation time and the operation time. Therefore, by shortening the holding time, the period during which the package is stored in the warehouse that is the starting point can be shortened, and the package can be reliably delivered by the expiration date. It is possible to keep freshness of a package such as food.

When the grace period from the check-in date/time of the package to the expiration date is long, the transportation plan is created so that the transportation time is shorter than the holding time and the operation time. Therefore, by shortening the transportation time, the time during which the package is loaded on the vehicle can be shortened.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. A program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps illustrated in the above flowchart are executed is for specifically describing the present disclosure, and may be any order other than the above order as long as a similar effect is obtained. Some of the above steps may be executed simultaneously (in parallel) with other steps.

The technique of the present disclosure is useful as a technique for creating a transportation plan for transporting one or more transportation objects by one or more vehicles since it is possible to shorten a holding time from when the transportation object arrives at a starting point to when the vehicle arrives at the starting point.

1. An information processing method in a computer, the method comprising:
acquiring a transportation request for each of one or more transportation objects, the transportation request including a starting point for starting transportation, an ending point for ending transportation, and a first arrival date/time that indicates a date and time at which each of the one or more transportation objects arrives at the starting point;
creating a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point; and
outputting the transportation plan created.

2. The information processing method according to claim 1, wherein in the creating of the transportation plan, the transportation plan that defines the one or more transportation objects to be transported by each of the one or more vehicles is created to minimize a sum of the one or more holding costs and the one or more transportation costs.

3. The information processing method according to claim 1, wherein in the creating of the transportation plan, the transportation plan is created by arranging, for each of the one or more vehicles, the starting point and the ending point for the one or more transportation objects to be transported by each of the one or more vehicles in time series.

4. The information processing method according to claim 1, wherein in the creating of the transportation plan, the transportation plan is created on a basis of a sum of one or more operation costs required for moving from a first departure point to the ending point at a last end of the vehicle, the one or more holding costs, and the one or more transportation costs for each of the one or more vehicles included in the transportation plan.

5. The information processing method according to claim 1, wherein in the creating of the transportation plan, when there is a plurality of starting point candidates for one transportation object among the one or more transportation objects, the starting point candidate having the sum that is smallest among the plurality of starting point candidates is used as the starting point of the one transportation object.

6. The information processing method according to claim 1, wherein
the one or more transportation objects include one or more packages,
the starting point includes a location of a warehouse that stores the package, and
in the creating of the transportation plan, the transportation plan is created so that one of the holding cost or the transportation cost is smaller than another one of the holding cost or the transportation cost on a basis of an average space occupancy rate obtained by dividing a sum of current storage volumes of one or more warehouses that store the one or more packages by a sum of maximum storage volumes of the one or more warehouses.

7. The information processing method according to claim 6, wherein in the creating of the transportation plan, the transportation plan is created so that the holding cost is smaller than the transportation cost when the average space occupancy rate is equal to or more than a first threshold, and the transportation plan is created so that the transportation cost is smaller than the holding cost when the average space occupancy rate is less than a second threshold.

8. The information processing method according to claim 1, wherein
the one or more transportation objects include one or more travelers, and
in the creating of the transportation plan, the transportation plan is created so that one of the holding cost or the transportation cost is smaller than another one of the holding cost or the transportation cost on a basis of a number of the one or more travelers included in the transportation request.

9. The information processing method according to claim 8, wherein in the creating of the transportation plan, the transportation plan is created so that the holding cost is smaller than the transportation cost when the number of the one or more travelers is equal to or more than a first threshold, and the transportation plan is created so that the transportation cost is smaller than the holding cost when the number of the one or more travelers is less than a second threshold.

10. The information processing method according to claim 1, wherein
the one or more transportation objects include one or more packages, and
in the creating of the transportation plan, the transportation plan is created so that one of the holding cost or the transportation cost is smaller than another one of the holding cost or the transportation cost on a basis of an average grace period obtained by dividing a sum of one or more grace periods from the first arrival date/time of each of the one or more packages to an expiration date of each of the one or more packages by a number of the one or more packages.

11. The information processing method according to claim 10, wherein in the creating of the transportation plan, the transportation plan is created so that the holding cost is smaller than the transportation cost when the average grace period is less than a first threshold, and the transportation plan is created so that the transportation cost is smaller than the holding cost when the average grace period is equal to or more than a second threshold.

12. An information processing device comprising:
an acquisition part that acquires a transportation request for each of one or more transportation objects, the transportation request including a starting point for starting transportation, an ending point for ending transportation, and a first arrival date/time that indicates a date and time at which each of the one or more transportation objects arrives at the starting point;
a creator that creates a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point; and
an output part that outputs the transportation plan created.

13. A non-transitory computer readable recording medium storing an information processing program that causes a computer to function to:
acquire a transportation request for each of one or more transportation objects, the transportation request including a starting point for starting transportation, an ending point for ending transportation, and a first arrival date/time that indicates a date and time at which each of the one or more transportation objects arrives at the starting point;
create a transportation plan for transporting the one or more transportation objects on a basis of a sum of one or more holding costs that correspond to a difference between the first arrival date/time and a second arrival date/time that indicates a date and time at which one or more vehicles transporting the transportation objects arrive at the starting point for each of the one or more transportation objects, and one or more transportation costs required for transporting each of the one or more transportation objects from the starting point to the ending point; and
output the transportation plan created.
